(19) United States
(12) Patent Application Publication
(10) Pub. No.: US 2022/0165247 A1
(43) Pub. Date: May 26, 2022

(54) METHOD FOR GENERATING SYNTHETIC SPEECH AND SPEECH SYNTHESIS SYSTEM

(71) Applicant: Xinapse Co., Ltd., Seoul (KR)

(72) Inventors: Jinbeom Kang, Seoul (KR); Dong Won Joo, Seoul (KR); Yongwook Nam, Seoul (KR); Seung Jae Lee, Gumi-si (KR)

(21) Appl. No.: 17/380,387

(22) Filed: Jul. 20, 2021

(30) Foreign Application Priority Data
Nov. 24, 2020 (KR) 10-2020-0158769
Nov. 24, 2020 (KR) 10-2020-0158770
Nov. 24, 2020 (KR) 10-2020-0158771
Nov. 24, 2020 (KR) 10-2020-0158772
Nov. 24, 2020 (KR) 10-2020-0158773
Nov. 25, 2020 (KR) 10-2020-0160373
Nov. 25, 2020 (KR) 10-2020-0160380
Nov. 25, 2020 (KR) 10-2020-0160393
Nov. 25, 2020 (KR) 10-2020-0160402

(51) Int. Cl. G10L 13/02; G10L 21/10; G10L 25/30; G06N 3/04

(52) U.S. Cl. CPC G10L 13/02; G06N 3/0454; G10L 25/30; G10L 21/10

(57) ABSTRACT

This application relates to a speech synthesis system. In one aspect, the system includes an encoder configured to generate a speaker embedding vector corresponding to a verbal speech based on a first speech signal corresponding to a verbal utterance. The system may also include a synthesizer configured to perform at least once the cycle including generating a plurality of spectrograms corresponding to verbal utterance of the sequence of the text, based on the speaker embedding vector and a sequence of a text written in a particular natural language and selecting a first spectrogram from among the spectrograms, to output the first spectrogram. The system may further include a vocoder configured to generate a second speech signal corresponding to the sequence of the text based on the first spectrogram.

### CROSS-REFERENCE TO RELATED APPLICATION

This application claims the benefit of Korean Patent Application Nos. 10-2020-0158769 filed on Nov. 24, 2020, 10-2020-0158770 filed on Nov. 24, 2020, 10-2020-0158771 filed on Nov. 24, 2020, 10-2020-0158772 filed on Nov. 24, 2020, 10-2020-0158773 filed on Nov. 24, 2020, 10-2020-0160373 filed on Nov. 25, 2020, 10-2020-0160380 filed on Nov. 25, 2020, 10-2020-0160393 filed on Nov. 25, 2020, and 10-2020-0160402 filed on Nov. 25, 2020, in the Korean Intellectual Property Office, the disclosures of all of which are incorporated herein in their entireties by reference.

### BACKGROUND

### Field

The present disclosure relates to a method for generating synthesized speech and a speech synthesis system.

### Description of the Related Technology

Recently, along with the developments in the artificial intelligence technology, interfaces using speech signals are becoming common. Therefore, researches are being actively conducted on speech synthesis technology that enables a synthesized speech to be uttered according to a given situation.

The speech synthesis technology is applied to many fields, such as virtual assistants, audio books, automatic interpretation and translation, and virtual voice actors, in combination with speech recognition technology based on artificial intelligence.

### SUMMARY

Provided is a method of generating a synthesized speech and a speech synthesis system. The present disclosure also provides an artificial intelligence-based speech synthesis technique capable of implementing a natural speech like a speech of an actual speaker. The present disclosure also provides a highly efficient artificial intelligence-based speech synthesis technology using a small amount of learning data.

Additional aspects will be set forth in part in the description which follows and, in part, will be apparent from the description, or may be learned by practice of the presented embodiments.

According to an aspect of an embodiment, a speech synthesis system includes an encoder configured to generate a speaker embedding vector corresponding to a verbal speech based on a first speech signal corresponding to a verbal utterance; a synthesizer configured to perform at least once the cycle including generating a plurality of spectrograms corresponding to verbal utterance of the sequence of the text based on the speaker embedding vector and a sequence of a text written in a particular natural language and selecting a first spectrogram from among the spectrograms, to output the first spectrogram; and a vocoder configured to generate a second speech signal corresponding to the sequence of the text based on the first spectrogram.

According to an aspect of another embodiment, there is provided a computer-readable recording medium having recorded thereon a program for executing the method on a computer.

According to an aspect of another embodiment, a method of generating a synthesized speech, the method includes generating a speaker embedding vector corresponding to a verbal speech based on a first speech signal corresponding to a verbal utterance; based on the speaker embedding vector and a sequence of a text written in a particular natural language, generating a plurality of spectrograms corresponding to verbal utterance of the sequence of the text; outputting a first spectrogram by performing at least once the cycle including generating the spectrograms and selecting the first spectrogram from among the generated spectrograms; and generating a second speech signal corresponding to the sequence of the text based on the first spectrogram.

A speech synthesis system may generate a plurality of mel-spectrograms, and a mel-spectrogram of the highest quality may be selected from among generated mel-spectrograms. Also, when generated mel-spectrograms do not satisfy a predetermined quality criterion, the speech synthesis system may perform a process of generating mel-spectrograms and selecting any one of them at least once. Accordingly, the speech synthesis system is capable of outputting a synthesized speech of the highest quality.

A speech synthesis system may divide a sequence of characters written in a particular natural language into sub-sequences. Also, the speech synthesis system may merge certain texts at the end of a sub-sequence. Therefore, the speech synthesis system may operate based on an optimum text length, thereby generating an optimum spectrogram.

By dividing a mel-spectrogram into sub mel-spectrograms based on silent portions of the mel-spectrogram and generating speech data from the sub mel-spectrograms, it is possible to generate more accurate speech data.

By generating speech data by using a silent mel-spectrogram, it is possible to generate more accurate speech data.

As a speech synthesis system calculates scores (an encoder score, a decoder score, and a final score) of an attention alignment, the quality of a mel-spectrogram corresponding to the attention alignment may be determined. Therefore, the speech synthesis system may select a mel-spectrogram of the highest quality from among a plurality of mel-spectrograms. Accordingly, the speech synthesis system is capable of outputting a synthesized speech of the highest quality.

### BRIEF DESCRIPTION OF THE DRAWINGS

These and/or other aspects will become apparent and more readily appreciated from the following description of the embodiments, taken in conjunction with the accompanying drawings.

FIG. 1 is a diagram schematically showing the operation of a speech synthesis system.

FIG. 2 is a diagram showing an embodiment of a speech synthesis system.

FIG. 3 is a diagram showing an embodiment of outputting a mel-spectrogram through a synthesizer.

FIG. 4 is a diagram for describing an example of an operation of a synthesizer.

FIG. 5 is a diagram for describing an example of an operation of a vocoder.

FIG. 6 is a flowchart of an example of a method of generating a synthesized speech.

FIG. 7 is a flowchart of an example of dividing a sequence into sub-sequences.

FIG. 8 is a diagram for describing an example in which a speech synthesis system divides a sequence.

FIG. 9 is a diagram for describing an example in which a speech synthesis system compares a length of a sub-sequence with a first threshold length and merges adjacent sub-sequences with one another.

FIG. 10 is a diagram for describing an example in which a speech synthesis system compares a length of a sub-sequence with a second threshold length and divides the sub-sequence.

FIG. 11 is a flowchart for describing an example in which a speech synthesis system performs a predetermined process on a sub-sequence and transmits the same to a synthesizer.

FIG. 12 is a diagram for describing an example in which a speech synthesis system merges a predetermined text at an end of a sub-sequence.

FIG. 13 is a diagram showing an embodiment of a synthesizer of a speech synthesis system.

FIG. 14 is a diagram showing a volume graph corresponding to a mel-spectrogram.

FIGS. 15 and 16 are diagrams for describing a process of dividing a mel-spectrogram into a plurality of sub mel-spectrograms.

FIG. 17 is a diagram for describing a process of generating speech data from a plurality of sub mel-spectrograms.

FIG. 18 is a diagram for describing an example of dividing a text sequence.

FIG. 19 is a diagram for describing a process of generating a final mel-spectrogram by adding a silent mel-spectrogram between sub mel-spectrograms.

FIG. 20 is a flowchart of a method of determining a silent portion of a mel-spectrogram according to an example embodiment.

FIGS. 21A and 21B are diagrams showing an example of a mel-spectrogram and an attention alignment.

FIGS. 22A and 22B are diagrams for describing the quality of an attention alignment.

FIG. 23 is a diagram for describing coordinate axes representing an attention alignment and the quality of the attention alignment.

FIG. 24 is a diagram for describing an example in which a synthesizer calculates an encoder score.

FIG. 25 is a diagram for describing an example in which a synthesizer calculates a decoder score.

FIG. 26 is a diagram for describing an example of extracting a portion having a valid meaning from an attention alignment.

FIGS. 27A, 27B and 27C are diagrams for describing a relationship between the quality of an attention alignment, an encoder score, and a decoder score.

FIG. 28 is a flowchart of an example of a method of calculating an encoder score for an attention alignment.

FIG. 29 is a flowchart of an example of a method of calculating a decoder score for an attention alignment.

FIG. 30 is a flowchart of an example of a method of calculating a final score for an attention alignment.

### DETAILED DESCRIPTION

Typical speech synthesis methods include various methods, such as a Unit Selection Synthesis (USS) and a HMM-based Speech Synthesis (HTS). The USS method is a method of cutting and storing speech data into phoneme units and finding and attaching suitable phonemes for a speech during speech synthesis. The HTS method is a method of extracting parameters corresponding to speech characteristics to generate a statistical model and reconstructing a text into a speech based on the statistical model. However, the above speech synthesis methods described above have many limitations in synthesizing a natural speech reflecting a speech style or an emotional expression of a speaker. Accordingly, recently, a speech synthesis method for synthesizing a speech from a text based on an artificial neural network is being spotlighted.

With respect to the terms in the various embodiments of the present disclosure, the general terms which are currently and widely used are selected in consideration of functions of structural elements in the various embodiments of the present disclosure. However, meanings of the terms may be changed according to intention, a judicial precedent, appearance of a new technology, and the like. In addition, in certain cases, a term which is not commonly used may be selected. In such a case, the meaning of the term will be described in detail at the corresponding part in the description of the present disclosure. Therefore, the terms used in the various embodiments of the present disclosure should be defined based on the meanings of the terms and the descriptions provided herein.

The present disclosure may include various embodiments and modifications, and embodiments thereof will be illustrated in the drawings and will be described herein in detail. However, this is not intended to limit the inventive concept to particular modes of practice, and it is to be appreciated that all changes, equivalents, and substitutes that do not depart from the spirit and technical scope of the inventive concept are encompassed in the present disclosure. The terms used in the present specification are merely used to describe particular embodiments, and are not intended to limit the present disclosure.

Terms used in the embodiments have the same meaning as commonly understood by one of ordinary skill in the art to which the embodiments belong, unless otherwise defined. Terms identical to those defined in commonly used dictionaries should be interpreted as having a meaning consistent with the meaning in the context of the related art and are not to be interpreted as ideal or overly formal in meaning unless explicitly defined in the present disclosure.

The detailed description of the present disclosure described below refers to the accompanying drawings, which illustrate specific embodiments in which the present disclosure may be practiced. These embodiments are described in detail sufficient to enable a one of ordinary skill in the art to practice the present disclosure. It should be understood that the various embodiments of the present disclosure are different from one another, but need not be mutually exclusive. For example, specific shapes, structures, and characteristics described in the present specification may be changed and implemented from one embodiment to another without departing from the spirit and scope of the present disclosure. In addition, it should be understood that positions or arrangement of individual elements in each embodiment may be changed without departing from the spirit and scope of the present disclosure. Therefore, the detailed descriptions to be given below are not made in a limiting sense, and the scope of the present disclosure should be taken as encompassing the scope claimed by the claims of the present disclosure and all scopes equivalent thereto. Like reference numerals in the drawings indicate the same or similar elements over several aspects.

Meanwhile, in the present specification, technical features that are individually described in one drawing may be implemented individually or at the same time.

In this specification, the term “unit” may refer to a hardware component, such as a processor or a circuit, and/or a software component executed by a hardware configuration, such as a processor.

Hereinafter, various embodiments of the present disclosure will be described in detail with reference to the accompanying drawings in order to enable one of ordinary skill in the art to easily implement the present disclosure.

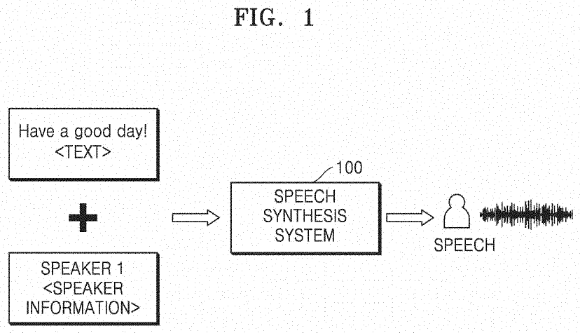

FIG. 1 is a diagram schematically showing the operation of a speech synthesis system.

A speech synthesis system 100 refers to a system that artificially converts text into human speech.

For example, the speech synthesis system 100 of FIG. 1 may be a speech synthesis system based on an artificial neural network. The artificial neural network refers to all models in which artificial neurons constituting a network through synaptic bonding have problem-solving ability by changing the strength of the synaptic bonding through learning.

For example, the speech synthesis system 100 may be implemented as various types of devices, such as a personal computer (PC), a server device, a mobile device, and an embedded device. The devices may correspond to smart phones, tablet devices, augmented reality (AR) devices, Internet of Things (IoT) devices, autonomous vehicles, robotics, medical devices, e-book terminals, and navigation devices that perform speech synthesis by using artificial neural networks, but are not limited thereto.

Furthermore, the speech synthesis system 100 may correspond to a dedicated hardware (HW) accelerator mounted on the above-stated devices. Alternatively, the speech synthesis system 100 may be, but is not limited to, a HW accelerator, such as a neural processing unit (NPU), a tensor processing unit (TPU), and a neural engine, which is a dedicated module for driving an artificial neural network.

Referring to FIG. 1, the speech synthesis system 100 may receive a text input and specific speaker information. For example, the speech synthesis system 100 may receive “Have a good day!” as a text input shown in FIG. 1 and may receive “Speaker 1” as a speaker information input.

“Speaker 1” may correspond to a speech signal or a speech sample indicating speech characteristics of a preset speaker 1. For example, speaker information may be received from an external device through a communication unit included in the speech synthesis system 100. Alternatively, speaker information may be input from a user through a user interface of the speech synthesis system 100 and may be selected as one of various speaker information previously stored in a database of the speech synthesis system 100, but the present disclosure is limited thereto.

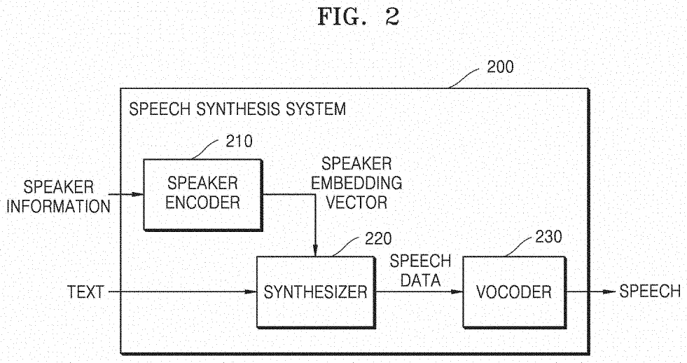

The speech synthesis system 100 may output a speech based on a text input received and specific speaker information received as inputs. For example, the speech synthesis system 100 may receive “Have a good day!” and “Speaker 1” as inputs and output a speech for “Have a good day!” reflecting the speech characteristics of the speaker 1. The speech characteristic of the speaker 1 may include at least one of various factors, such as a voice, a prosody, a pitch, and an emotion of the speaker 1. In other word, the output speech may be a speech that sounds like the speaker 1 naturally pronouncing “Have a good day!”. Detailed operations of the speech synthesis system 100 will be described later with reference to FIGS. 2 to 4.

FIG. 2 is a diagram showing an embodiment of a speech synthesis system.

A speech synthesis system 200 of FIG. 2 may be the same as the speech synthesis system 100 of FIG. 1.

Referring to FIG. 2, the speech synthesis system 200 may include a speaker encoder 210, a synthesizer 220 and a vocoder 230. Meanwhile, in the speech synthesis system 200 shown in FIG. 2, only components related to an embodiment are shown. Therefore, it would be obvious to one of ordinary skill in the art that the speech synthesis system 200 may further include other general-purpose components in addition to the components shown in FIG. 2.

The speech synthesis system 200 of FIG. 2 may receive speaker information and a text as inputs and output a speech.

For example, the speaker encoder 210 of the speech synthesis system 200 may receive speaker information as an input and generate a speaker embedding vector. The speaker information may correspond to a speech signal or a speech sample of a speaker. The speaker encoder 210 may receive a speech signal or a speech sample of a speaker, extract speech characteristics of the speaker, and represent the same as an embedding vector.

The speech characteristics may include at least one of various factors, such as a speech speed, a pause period, a pitch, a tone, a prosody, an intonation, and an emotion. In other words, the speaker encoder 210 may represent discontinuous data values included in the speaker information as a vector including consecutive numbers. For example, the speaker encoder 210 may generate a speaker embedding vector based on at least one of or a combination of two or more of various artificial neural network models, such as a pre-net, a CBHG module, a deep neural network (DNN), a convolutional neural network (CNN), a recurrent neural network (RNN), a long short-term memory network (LSTM), and a bidirectional recurrent deep neural network (BRDNN).

For example, the synthesizer 220 of the speech synthesis system 200 may receive a text and an embedding vector indicating speech characteristics of a speaker as inputs and output speech data.

For example, the synthesizer 220 may include a text encoder (not shown) and a decoder (not shown). Meanwhile, it would be obvious to one of ordinary skill in the art that the synthesizer 220 may further include other general-purpose components in addition to the above-stated components.

An embedding vector representing the speech characteristics of a speaker may be generated by the speaker encoder 210 as described above, and an the text encoder (not shown) or the decoder (not shown) of the synthesizer 220 may receive the embedding vector representing the speech characteristics of the speaker from the speaker encoder 210.

The text encoder (not shown) of the synthesizer 220 may receive a text as an input and generate a text embedding vector. A text may include a sequence of characters in a particular natural language. For example, a sequence of characters may include alphabetic characters, numbers, punctuation marks, or other special characters.

The text encoder (not shown) may divide an input text into letters, characters, or phonemes and input the divided text into an artificial neural network model. For example, the text encoder (not shown) may generate a text embedding vector based on at least one of or a combination of two or more of various artificial neural network models, such as a pre-net, a CBHG module, a DNN, a CNN, an RNN, an LSTM, and a BRDNN.

Alternatively, the text encoder (not shown) may divide an input text into a plurality of short texts and may generate a plurality of text embedding vectors in correspondence to the respective short texts.

The decoder (not shown) of the synthesizer 220 may receive a speaker embedding vector and a text embedding vector as inputs from the speaker encoder 210. Alternatively, the decoder (not shown) of the synthesizer 220 may receive a speaker embedding vector as an input from the speaker encoder 210 and may receive a text embedding vector as an input from the text encoder (not shown).

The decoder (not shown) may generate speech data corresponding to the input text by inputting the speaker embedding vector and the text embedding vector into an artificial neural network model. In other words, the decoder (not shown) may generate speech data for the input text in which the speech characteristics of a speaker are reflected. For example, the speech data may correspond to a spectrogram or a mel-spectrogram corresponding to an input text, but is not limited thereto. In other words, a spectrogram or a mel-spectrogram corresponds to a verbal utterance of a sequence of characters composed of a specific natural language.

A spectrogram is a graph that visualizes the spectrum of a speech signal. The x-axis of the spectrogram represents time, the y-axis represents frequency, and values of respective frequencies per time may be expressed in colors according to the sizes of the values. The spectrogram may be a result of performing a short-time Fourier transformation (STFT) on a continuous speech signal (consecutive speech signals?).

The STFT is a method of dividing a speech signal into sections of a certain length and applying a Fourier transformation to each section. In this case, since a result of performing the STFT on a speech signal is a complex value, phase information may be lost by taking an absolute value for the complex value, and a spectrogram including only magnitude information may be generated.

On the other hand, the mel-spectrogram is a result of re-adjusting a frequency interval of the spectrogram to a mel-scale. Human auditory organs are more sensitive in a low frequency band than in a high frequency, and the mel-scale expresses the relationship between physical frequencies and frequencies actually perceived by a person by reflecting the characteristic. A mel-spectrogram may be generated by applying a filter bank based on the mel-scale to a spectrogram.

Meanwhile, although not shown in FIG. 2, the synthesizer 220 may further include an attention module for generating an attention alignment. The attention module is a module that learns to which output from among outputs of all time-steps of a text encoder (not shown) an output of a specific time-step of a decoder is most related. A higher quality spectrogram or mel-spectrogram may be output by using the attention module.

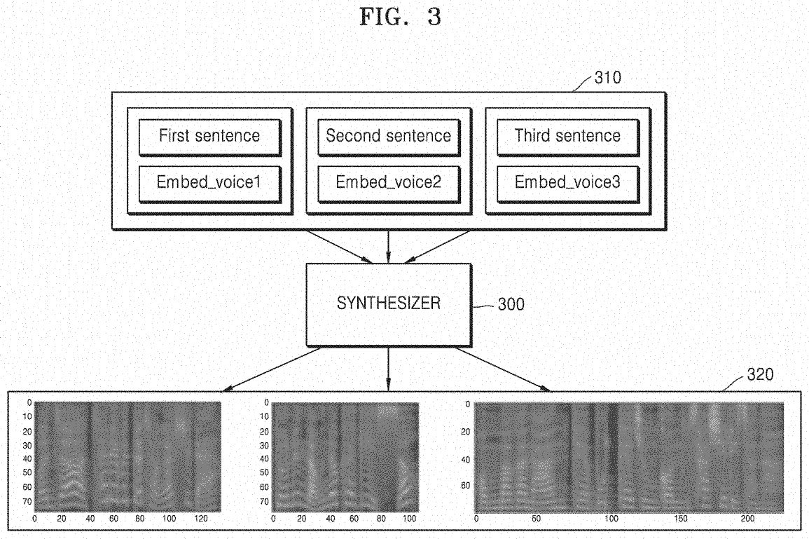

FIG. 3 is a diagram showing an embodiment of outputting a mel-spectrogram through a synthesizer.

A synthesizer 300 of FIG. 3 may be the same as the synthesizer 220 of FIG. 2.

Referring to FIG. 3, the synthesizer 300 may receive a list including input texts and speaker embedding vectors corresponding thereto. For example, the synthesizer 300 may receive a list 310 including an input text ‘first sentence’, a speaker embedding vector embed_voice1 corresponding thereto, an input text ‘second sentence’, a speaker embedding vector embed_voice2 corresponding thereto, and an input text ‘third sentence’, and a speaker embedding vector embed_voice3 corresponding thereto as an input.

The synthesizer 300 may generate mel-spectrograms 320 as many as the number of input texts included in the received list 310. Referring to FIG. 3, it may be seen that mel-spectrograms corresponding to input texts ‘first sentence’, ‘second sentence’, and ‘third sentence’ are generated.

Alternatively, the synthesizer 300 may generate the mel-spectrograms 320 and attention alignments as many as the number of input texts together. Although not shown in FIG. 3, for example, attention alignments respectively corresponding to the input texts ‘first sentence’, ‘second sentence’, and ‘third sentence’ may be additionally generated. Alternatively, the synthesizer 300 may generate a plurality of mel-spectrograms and a plurality of attention alignments for each of the input texts.

Returning back to FIG. 2, the vocoder 230 of the speech synthesis system 200 may generate speech data output from the synthesizer 220 into an actual speech. Speech data output as described above may be a spectrogram or a mel-spectrogram.

For example, the vocoder 230 may generate speech data output from the synthesizer 220 as an actual speech signal by using an inverse short-time Fourier transformation (ISTFT). However, since a spectrogram or a mel-spectrogram does not include phase information, it is unable to completely restore an actual speech signal by using the ISTFT only.

Therefore, the vocoder 230 may generate speech data output from the synthesizer 220 as an actual speech signal by using a Griffin-Lim algorithm, for example. The Griffin-Lim algorithm is an algorithm that estimates phase information from size information of a spectrogram or a mel-spectrogram.

Alternatively, the vocoder 230 may generate speech data output from the synthesizer 220 as an actual speech signal based on, for example, a neural vocoder.

The neural vocoder is an artificial neural network model that receives a spectrogram or a mel-spectrogram as an input and generates a speech signal. The neural vocoder may learn the relationship between a spectrogram or a mel-spectrogram and a speech signal through a large amount of data, thereby generating a high-quality actual speech signal.

The neural vocoder may correspond to a vocoder based on an artificial neural network model such as a WaveNet, a Parallel WaveNet, a WaveRNN, a WaveGlow, or a MelGAN, but is not limited thereto.

For example, a WaveNet vocoder includes a plurality of dilated causal convolution layers and is an autoregressive model that uses sequential characteristics between speech samples. For example, a WaveRNN vocoder is an autoregressive model that replaces a plurality of dilated causal convolution layers of a WaveNet vocoder with a Gated Recurrent Unit (GRU).

For example, a WaveGlow vocoder may learn to produce a simple distribution, such as a Gaussian distribution, from a speech dataset (x) by using an invertible transformation function. The WaveGlow vocoder may output a speech signal from a Gaussian distribution sample by using the inverse function of a transform function after learning is completed.

As described above with reference to FIGS. 2 and 3, synthesizers 220 and 300 according to an example embodiment may generate a plurality of spectrograms (or mel-spectrograms). In detail, the synthesizers 220 and 300 may generate a plurality of spectrograms (or mel-spectrograms) for a single input pair consisting of an input text and a speaker embedding vector.

Also, the synthesizers 220 and 300 may calculate a score of an attention alignment corresponding to each of the plurality of spectrograms (or mel-spectrograms). Specifically, the synthesizers 220 and 300 may calculate an encoder score, a decoder score, and a total score of an attention alignment. Therefore, the synthesizers 220 and 300 may select any one of the plurality of spectrograms (or mel-spectrograms) based on calculated scores. Here, a selected spectrogram (or mel-spectrogram) may represent the highest quality synthesized speech for a single input pair.

Also, the vocoder 230 may generate a speech signal by using the spectrogram (or mel-spectrogram) transmitted from the synthesizers 220 and 300. In this case, the vocoder 230 may select any one of a plurality of algorithms to be used to generate a speech signal according to expected quality and an expected generation speed of the speech signal to be generated. Also, the vocoder 230 may generate a speech signal based on a selected algorithm.

Therefore, speech synthesis systems 100 and 200 may generate a synthesized speech that satisfies quality and speed conditions.

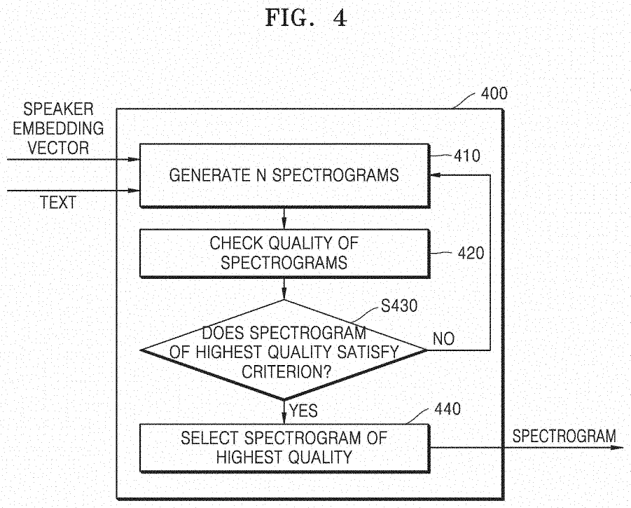

Hereinafter, examples in which the synthesizers 220 and 300 and the vocoder 230 operate will be described in detail with reference to FIGS. 4 to 6. Although it is described below that the synthesizers 220 and 300 select any one of a plurality of spectrograms (or a plurality of mel-spectrograms), modules for selecting a spectrogram (or a mel-spectrogram) may not be the synthesizers 220 and 300. For example, a spectrogram (or mel-spectrogram) may be selected by a separate module included in the speech synthesis systems 100 and 200 or another module separated from the speech synthesis systems 100 and 200.

Also, hereinafter, a spectrogram and a mel-spectrogram will be described as terms that may be used interchangeably with each other. In other words, even when the term spectrogram is used in the descriptions below, it may be replaced with the term mel-spectrogram. Also, even when the term mel-spectrogram is used in the descriptions below, it may be replaced with the term spectrogram.

FIG. 4 is a diagram for describing an example of an operation of a synthesizer.

A synthesizer 400 shown in FIG. 4 may be the same module as the synthesizer 220 shown in FIG. 2 or the synthesizer 300 shown in FIG. 3. In detail, the synthesizer 400 may generate a plurality of spectrograms by using an input text and a speaker embedding vector and select any one of them.

In operation 410, the synthesizer 400 generates n spectrograms by using a single pair of an input text and a speaker embedding vector (where n is a natural number equal to or greater than 2).

For example, the synthesizer 400 may include an encoder neural network and an attention-based decoder recurrent neural network. Here, the encoder neural network generates an encoded representation of each of characters included in a sequence of an input text by processing the sequence of the input text. Also, the attention-based decoder recurrent neural network processes a decoder input and an encoded representation to generate a single frame of a spectrogram for each decoder input in a sequence input from the encoder neural network.

In the prior art, since there was no reason to generate a plurality of spectrograms, a single spectrogram was usually generated from a single input text and a single speaker embedding vector. Therefore, when the quality of a generated spectrogram is low, the quality of a final speech (i.e., a synthesized speech) is also low.

Meanwhile, the synthesizer 400 according to an embodiment of the present disclosure generates a plurality of spectrograms by using a single input text and a single speaker embedding vector. As the synthesizer 400 includes an encoder neural network and a decoder neural network, each time a spectrogram is generated, the quality of the corresponding spectrogram may not be uniform. Therefore, the synthesizer 400 may generate a plurality of spectrograms for a single input text and a single speaker embedding vector and select a spectrogram of the highest quality from among generated spectrograms, thereby improving the quality of a synthesized speech.

In operation 420, the synthesizer 400 checks the quality of generated spectrograms.

For example, the synthesizer 400 may check the quality of spectrograms by using attention alignments corresponding to the spectrograms, respectively. In detail, attention alignments may be generated in correspondence to spectrograms, respectively. For example, when the synthesizer 400 generates a total of n spectrograms, attention alignments may be generated in correspondence to the n spectrograms, respectively. Accordingly, the quality of corresponding spectrograms may be determined through attention alignments.

For example, when an amount of data is not large or sufficient learning is not performed, the synthesizer 400 may not be able to generate a high-quality spectrogram. Attention alignment may be interpreted as a history of every moment that the synthesizer 400 concentrates on generation of a spectrogram.

For example, when a line representing the attention alignment is dark and there is little noise, it may be interpreted that the synthesizer 400 confidently performed inference at every moment of generation of a spectrogram. In other words, in the case of the example, it may be determined that the synthesizer 400 has generated a high-quality spectrogram. Therefore, the quality of the attention alignment (e.g., a degree to which the color of the attention alignment is dark, a degree to which the outline of the attention alignment is clear, etc.) may be used as a very important index for estimating an inference quality of the synthesizer 400.

For example, the synthesizer 400 may calculate an encoder score and a decoder score of an attention alignment. Next, the synthesizer 400 may calculate a total score of the attention alignment by combining the encoder score and the decoder score.

In operation 430, the synthesizer 400 determines whether the spectrogram of the highest quality satisfies a predetermined criterion.

For example, the synthesizer 400 may select an attention alignment having the highest score from among scores of attention alignments. Here, the score may be at least one of an encoder score, a decoder score, and a total score. Next, the synthesizer 400 may determine whether a corresponding score satisfies a predetermined criterion.

Selecting the highest score by the synthesizer 400 is the same as selecting a spectrogram of the highest quality from among n spectrograms generated through operation 410. Therefore, as the synthesizer 400 compares the highest score with a predetermined criterion, the same effect of determining whether a spectrogram of the highest quality from among n spectrograms satisfies a predetermined criterion may be obtained.

For example, a predetermined criterion may be a particular value of a score. In other words, the synthesizer 400 may determine whether the spectrogram of the highest quality satisfies the predetermined criterion based on whether the highest score is equal to or greater than a particular value.

When the spectrogram of the highest quality does not satisfy the predetermined criterion, the process proceeds to operation 410. When the spectrogram of the highest quality does not satisfy the predetermined criterion, it means that all of remaining n-1 spectrograms do not satisfy the predetermined criterion. Therefore, the synthesizer 400 re-generates n spectrograms by performing operation 410 again. Next, the synthesizer 400 performs operations 420 and 430 again. In other words, the synthesizer 400 repeats operations 410 to 430 at least once depending on whether a spectrogram of the highest quality satisfies the predetermined criterion.

When the spectrogram of the highest quality satisfies the predetermined criterion, the process proceeds to operation 440.

In operation 440, the synthesizer 400 selects the spectrogram of the highest quality. Next, the synthesizer 400 transmits a selected spectrogram to the vocoder 230.

In other words, the synthesizer 400 selects a spectrogram corresponding to a score that satisfies the predetermined criterion through operation 430. Next, the synthesizer 400 transmits a selected spectrogram to the vocoder 230. Therefore, the vocoder 230 may generate a high-quality synthesized speech that satisfies the predetermined criterion.

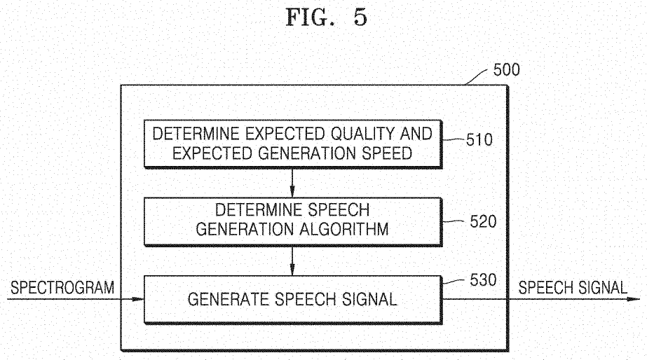

FIG. 5 is a diagram for describing an example of an operation of a vocoder.

A vocoder 500 shown in FIG. 5 may be the same module as the vocoder 230 shown in FIG. 2. In detail, the vocoder 500 may generate a speech signal by using a spectrogram.

In operation 510, the vocoder 500 determines an expected quality and an expected generation speed.

The vocoder 500 affects the quality of a synthesized speech and speeds of the speech synthesis systems 100 and 200. For example, when the vocoder 500 employs a precise algorithm, the quality of a synthesized speech may be improved, but a speed at which the synthesized speech is generated may decrease. On the contrary, when the vocoder 500 employs an algorithm with low precision, the quality of a synthesized speech may decrease, but a speed at which the synthesized speech is generated may increase. Therefore, the vocoder 500 may determine the expected quality and the expected generation speed of a synthesized speech, and a speech generation algorithm may be determined based on the same.

In operation 520, the vocoder 500 determines a speech generation algorithm according to the expected quality and the expected generation speed determined in operation 510.

For example, when the quality of a synthesized speech is more important than the generation speed of the synthesized speech, the vocoder 500 may select a first speech generation algorithm. Here, the first speech generation algorithm may be an algorithm according to WaveRNN, but is not limited thereto.

On the contrary, when the generation speed of the synthesized speech is more important than the quality of a synthesized speech, the vocoder 500 may select a second speech generation algorithm. Here, the second speech generation algorithm may be an algorithm according to MelGAN, but is not limited thereto.

In operation 530, the vocoder 500 generates a speech signal according to the speech generation algorithm determined in operation 520.

In detail, the vocoder 500 generates a speech signal by using a spectrogram output from the synthesizer 400.

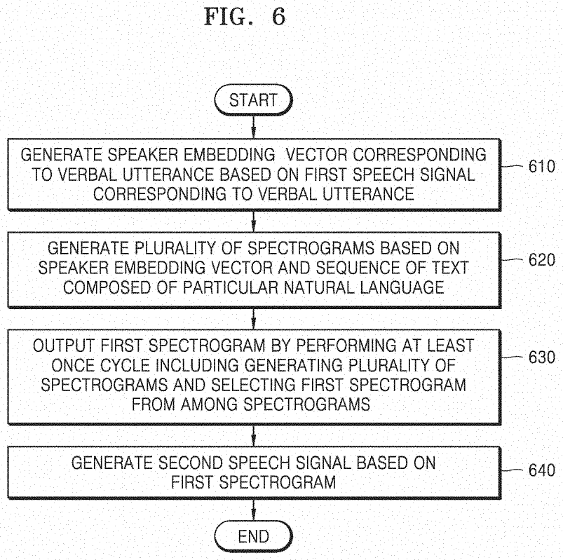

FIG. 6 is a flowchart of an example of a method of generating a synthesized speech.

Referring to FIG. 6, a method of generating a synthesized speech includes operations processed in a time series in the speech synthesis systems 100 and 200 shown in FIGS. 1 to 5. Therefore, it is obvious that, even when omitted below, the descriptions given above with respect to the speech synthesis systems 100 and 200 shown in FIGS. 1 to 5 may also be applied to the method of generating a synthesized speech of FIG. 6.

In operation 610, the speech synthesis systems 100 and 200 generate a speaker embedding vector corresponding to a verbal utterance based on a first speech signal corresponding to the verbal utterance.

In detail, the speaker encoder 210 generates a speaker embedding vector based on speaker information corresponding to a verbal utterance. An example in which the speaker encoder 210 generates a speaker embedding vector is as described above with reference to FIGS. 2 and 3.

In operation 620, the speech synthesis systems 100 and 200 generate a plurality of spectrograms based on a speaker embedding vector and a sequence of a text composed of a specific natural language.

In detail, synthesizers 220, 300, and 400 generate a plurality of spectrograms based on a speaker embedding vector and a sequence of a text. An example in which the synthesizers 220, 300, and 400 generate a plurality of spectrograms is as described above with reference to FIGS. 2 to 4.

In operation 630, the speech synthesis systems 100 and 200 output a first spectrogram by generating a plurality of spectrograms and selecting a first spectrogram from among the spectrograms at least once.

In detail, when a spectrogram of the highest quality from among the spectrograms generated in operation 620 does not satisfy a predetermined criterion, the synthesizers 220, 300, and 400 re-generate a plurality of spectrograms and determine whether a spectrogram of the highest quality from among re-generated spectrograms satisfies the predetermined criterion. In other words, the synthesizers 220, 300, and 400 repeat operation 620 and operation 630 at least once depending on whether a spectrogram of the highest quality satisfies the predetermined criterion. An example in which the synthesizers 220, 300, and 400 output a first spectrogram is as described above with reference to FIGS. 2 to 4.

In operation 640, the speech synthesis systems 100 and 200 generate a second speech signal based on the first spectrogram.

In detail, vocoders 230 and 500 generate a synthesized speech based on spectrograms transmitted from the synthesizers 220, 300, and 400. An example in which the vocoders 230 and 500 generate the second speech signal is as described above with reference to FIGS. 2, 3, and 5.

Meanwhile, when the length of a sequence is too long or too short, the synthesizers 220 and 300 may not be able to generate high-quality spectrograms (or mel-spectrograms). In other words, when the length of a sequence is too long or too short, an attention-based decoder recurrent neural network included in the synthesizers 220 and 300 may not be able to generate a high-quality spectrogram (or mel-spectrogram).

Therefore, the speech synthesis systems 100 and 200 according to an embodiment divide a sequence input to the synthesizers 220 and 300 into a plurality of sub-sequences. Here, divided sub-sequences have respective lengths optimized for the synthesizers 220 and 300 to generate a high-quality spectrogram (or mel-spectrogram).

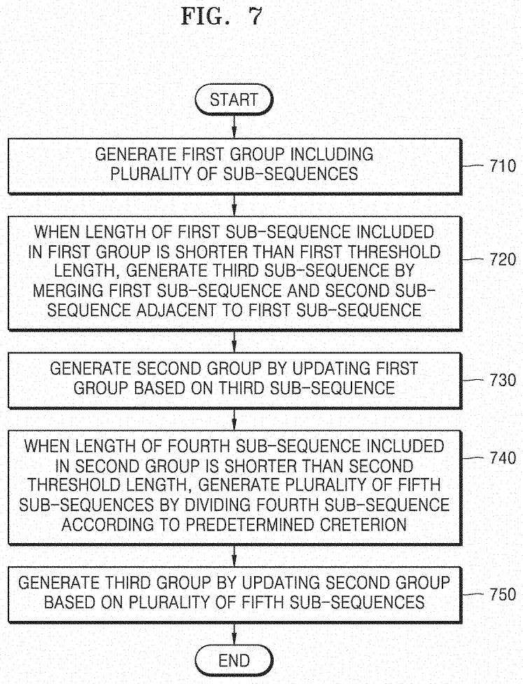

Hereinafter, examples in which the speech synthesis systems 100 and 200 divide a sequence of characters composed of a particular natural language into a plurality of sub-sequences will be described with reference to FIGS. 7 to 12. For example, a module for dividing a sequence into a plurality of sub-sequences may be a separate module included in the speaker encoder 210, the synthesizers 220 and 300, or the speech synthesis systems 100 and 200.

Also, hereinafter, a spectrogram and a mel-spectrogram will be described as terms that may be used interchangeably with each other. In other words, even when the term spectrogram is used in the descriptions below, it may be replaced with the term mel-spectrogram. Also, even when the term mel-spectrogram is used in the descriptions below, it may be replaced with the term spectrogram.

FIG. 7 is a flowchart of an example of dividing a sequence into sub-sequences.

Referring to FIG. 7, a method of dividing a sequence into sub-sequences includes operations processed in a time series in the speech synthesis systems 100 and 200 shown in FIGS. 1 and 2. Therefore, it is obvious that, even when omitted below, the descriptions given above with respect to the speech synthesis systems 100 and 200 shown in FIGS. 1 to 5 may also be applied to the method of dividing a sequence into sub-sequences of FIG. 7.

In operation 710, the speech synthesis systems 100 and 200 generate a first group including a plurality of sub-sequences by dividing a sequence based on at least one punctuation mark included in the sequence.

For example, when any one of predetermined punctuation marks is included in a sequence, the speech synthesis systems 100 and 200 may divide the sequence based on the corresponding punctuation mark. Here, the predetermined punctuation marks may include at least one of ‘,’, ‘.’, ‘?’, ‘!’, ‘;’, ‘-’, and ‘\hat{ }’.

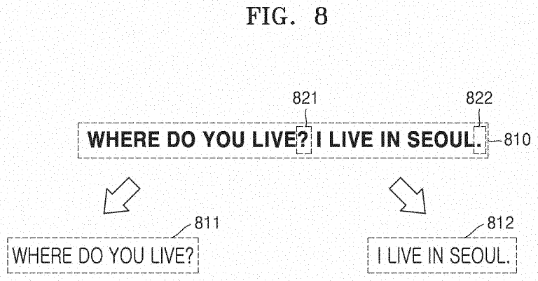

Hereinafter, an example in which the speech synthesis systems 100 and 200 divide a sequence based on a predetermined punctuation mark will be described with reference to FIG. 8.

FIG. 8 is a diagram for describing an example in which a speech synthesis system divides a sequence.

FIG. 8 shows an example of a sequence 810 of characters composed of a particular natural language. Also, the sequence 810 includes two types of punctuation marks 821 and 822.

The speech synthesis systems 100 and 200 identify characters and punctuation marks included in the sequence 810. Next, the speech synthesis systems 100 and 200 check whether the punctuation marks 821 and 822 included in the sequence 810 correspond to predetermined punctuation marks.

When the punctuation marks 821 and 822 correspond to the predetermined punctuation marks, the speech synthesis systems 100 and 200 divide the sequence 810 into sub-sequences 811 and 812. For example, when a punctuation mark ‘?’ and a punctuation mark ‘,’ are predetermined punctuation marks, the speech synthesis systems 100 and 200 generate the sub-sequences 811 and 812 by dividing the sequence 810.

The speech synthesis systems 100 and 200 generate a first group including the sub-sequences 811 and 812. For example, in the case of the sequence 810 shown in FIG. 8, a total of two sub-sequences 811 and 812 are included in the first group.

Referring back to FIG. 7, in operation 720, when the length of a first sub-sequence included in the first group is shorter than a first threshold length, the first sub-sequence and a second sub-sequence adjacent to the first sub-sequence are merged, thereby generating a third sub-sequence.

The speech synthesis systems 100 and 200 compare lengths of sub-sequences included in the first group with the first threshold length. Next, the speech synthesis systems 100 and 200 merge a sub-sequence shorter than the first threshold length with a sub-sequence adjacent thereto. For example, the first threshold length may be determined in advance and may be adjusted according to the specifications of the speech synthesis systems 100 and 200.

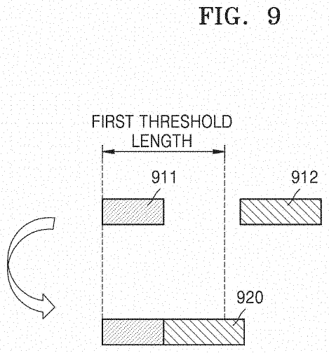

Hereinafter, an example in which the speech synthesis systems 100 and 200 compare lengths of sub-sequences included in the first group with the first threshold length and merge adjacent sub-sequences will be described with reference to FIG. 9.

FIG. 9 is a diagram for describing an example in which a speech synthesis system compares a length of a sub-sequence with a first threshold length and merges adjacent sub-sequences with one another.

FIG. 9 shows sub-sequences 911 and 912 included in the first group. Here, it is assumed that the sub-sequences 911 and 912 are adjacent to each other. In other words, it is assumed that a sub-sequence 912 is located immediately after the sub-sequence 911 in a sequence.

The speech synthesis systems 100 and 200 compare the length of the sub-sequence 911 with the first threshold length. When the length of the sub-sequence 911 is shorter than the first threshold length, the speech synthesis systems 100 and 200 generate a sub-sequence 920 by merging the sub-sequence 911 and the sub-sequence 912. Here, merging means connecting the sub-sequence 912 to the end of the sub-sequence 911.

When the length of the sub-sequence 911 is shorter than the first threshold length, the synthesizers 220 and 300 may not be able to generate an optimal spectrogram. Therefore, the speech synthesis systems 100 and 200 may improve the quality of a spectrogram generated by the synthesizers 220 and 300 by merging the sub-sequence 911 and the sub-sequence 912.

Referring back to FIG. 7, in operation 730, the speech synthesis systems 100 and 200 generate a second group by updating the first group based on a third sub-sequence.

As described above with reference to operation 720, the speech synthesis systems 100 and 200 may selectively merge at least some of sub-sequences included in the first group. In other words, when lengths of sub-sequences included in the first group are all longer than the first threshold length, the sub-sequences are not merged.

Therefore, the second group may include a sequence in which some of the sub-sequences included in the first group are merged or the sub-sequences of the first group may be included in the second group as-is.

In operation 740, when the length of a fourth sub-sequence included in the second group is longer than a second threshold length, the speech synthesis systems 100 and 200 generate a plurality of fifth sub-sequences by dividing the fourth sub-sequence according to a predetermined criterion.

The speech synthesis systems 100 and 200 compare lengths of sub-sequences included in the second group with the second threshold length. Next, the speech synthesis systems 100 and 200 divide a sub-sequence longer than the second threshold length. For example, the second threshold length may be determined in advance and may be adjusted according to the specifications of the speech synthesis systems 100 and 200. Also, the second threshold length may be set to be longer than the first threshold length.

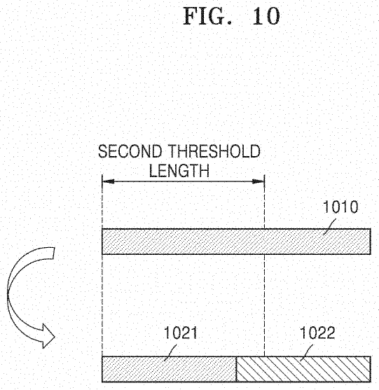

Hereinafter, an example in which the speech synthesis systems 100 and 200 compare lengths of sub-sequences included in the second group with the second threshold length and divide sub-sequences will be described with reference to FIG. 10.

FIG. 10 is a diagram for describing an example in which a speech synthesis system compares a length of a sub-sequence with a second threshold length and divides the sub-sequence.

FIG. 10 shows a sub-sequence 1010 included in the second group. The speech synthesis systems 100 and 200 compare the length of the sub-sequence 1010 with the second threshold length. When the length of the sub-sequence 1010 is longer than the second threshold length, the speech synthesis systems 100 and 200 generate a plurality of sub-sequences 1021 and 1022 by dividing the sub-sequence 1010. Although FIG. 10 shows that there are total of two sub-sequences 1021 and 1022, the present disclosure is not limited thereto. In other words, the sub-sequence 1010 may be divided into three or more sub-sequences.

When the length of the sub-sequence 1010 is longer than the second threshold length, the synthesizers 220 and 300 may not be able to generate an optimal spectrogram. Therefore, the speech synthesis systems 100 and 200 may improve the quality of a spectrogram generated by the synthesizers 220 and 300 by dividing the sub-sequence 1010.

The sub-sequence 1010 may be divided according to various criteria. For example, the sub-sequence 1010 may be divided based on a point at which an speaker breathes when the sub-sequence 1010 is uttered. In another example, the sub-sequence 1010 may be divided based on a space included in the sub-sequence 1010. However, the criteria for dividing the sub-sequence 1010 are not limited to the examples.

Referring back to FIG. 7, in operation 750, the speech synthesis systems 100 and 200 generate a third group by updating the second group based on the plurality of fifth sub-sequences.

As described above with reference to operation 740, the speech synthesis systems 100 and 200 may selectively divide at least some of sub-sequences included in the second group. In other words, when lengths of sub-sequences included in the second group are all shorter than the second threshold length, the sub-sequences are not divided.

Therefore, the third group may include a sequence in which some of the sub-sequences included in the second group are divided or the sub-sequences of the second group may be included in the third group as-is.

Although not shown in FIG. 7, when two or more unit blanks are included in a sequence, the speech synthesis systems 100 and 200 may modify the sequence by changing the two or more unit blanks to one unit blank. In detail, before operation 710 is performed, the speech synthesis systems 100 and 200 check arrangements of spaces in a sequence and, when the sequence include two or more consecutive unit blanks, may change the two or more consecutive unit blanks to one unit blank.

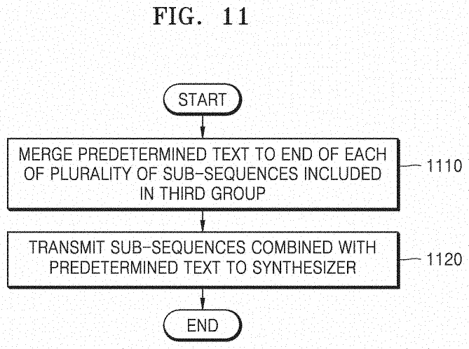

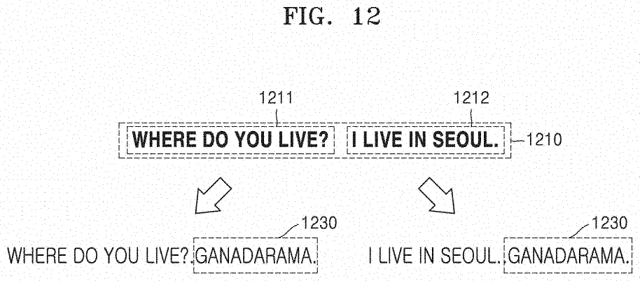

Meanwhile, the speech synthesis systems 100 and 200 may perform predetermined processing on sub-sequences included in the third group before transmitting the sub-sequences to the synthesizers 220 and 300. An example in which the speech synthesis systems 100 and 200 perform predetermined processing on sub-sequences will be described with reference to FIGS. 11 and 12.

FIG. 11 is a flowchart for describing an example in which a speech synthesis system performs a predetermined process on a sub-sequence and transmits the same to a synthesizer.

In operation 1110, the speech synthesis systems 100 and 200 merge a predetermined text at the ends of the plurality of sub-sequences included in the third group.

The location sensitive attention-based synthesizers 220 and 300 may generate a better spectrogram when a certain amount of text is further included at the end of a sub-sequence. Therefore, the speech synthesis systems 100 and 200 may merge a predetermined text at the ends of sub-sequences included in the third group, if needed.

Hereinafter, an example in which the speech synthesis systems 100 and 200 merge a predetermined text at the end of a sub-sequence will be described with reference to FIG. 12.

FIG. 12 is a diagram for describing an example in which a speech synthesis system merges a predetermined text at an end of a sub-sequence.

Referring to FIG. 12, the speech synthesis systems 100 and 200 may generate sub-sequences 1211 and 1212 by dividing a sequence 1210. Here, it is assumed that the sub-sequences 1211 and 1212 are sub-sequences included in the third group.

The speech synthesis systems 100 and 200 merge a predetermined text 1230 at the end of each of the sub-sequences 1211 and 1212. Although FIG. 12 shows that the predetermined text 1230 is ‘GANADARAMA’, the present disclosure is not limited thereto. In other words, the predetermined text 1230 may be variously set, such that the synthesizers 220 and 300 generate a high-quality spectrogram.

Referring back to FIG. 11, in operation 1120, the speech synthesis systems 100 and 200 transmit a sub-sequence to which a predetermined text is merged to the synthesizers 220 and 300.

When the predetermined text 1230 is merged at the end of each of the sub-sequences 1211 and 1212, the speech synthesis systems 100 and 200 transmits information regarding the predetermined text 1230 to the synthesizers 220 and 300 together. Therefore, the synthesizers 220 and 300 may finally generate a spectrogram from which the predetermined text 1230 is excluded.

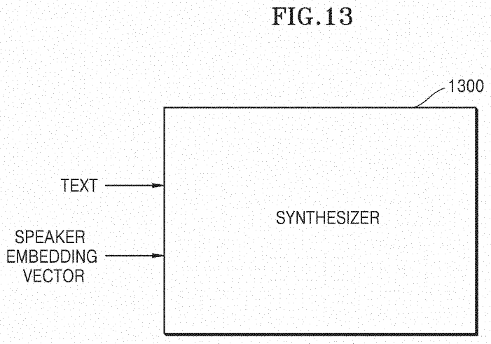

FIG. 13 is a diagram showing an embodiment of a synthesizer of a speech synthesis system.

A synthesizer 1300 of FIG. 13 may be the same as the synthesizer 220 of FIG. 2.

Referring to FIG. 13, the synthesizer 1300 of the speech synthesis system 200 may include an encoder and a decoder. Meanwhile, it would be obvious to one of ordinary skill in the art that the synthesizer 1300 may further include other general-purpose components in addition to the above-stated components.

An embedding vector representing the speech characteristics of a speaker may be generated by the speaker encoder 210 as described above, and an encoder or a decoder of the synthesizer 1300 may receive the embedding vector representing the speech characteristics of the speaker from the speaker encoder 210.

The encoder of the synthesizer 1300 may receive a text as an input and generate a text embedding vector. A text may include a sequence of characters in a particular natural language. For example, a sequence of characters may include alphabetic characters, numbers, punctuation marks, or other special characters.

The encoder of the synthesizer 1300 may divide an input text into letters, characters, or phonemes and input the divided text into an artificial neural network model. For example, the encoder of the synthesizer 1300 may generate a text embedding vector based on at least one of or a combination of two or more of various artificial neural network models, such as a pre-net, a CBHG module, a DNN, a CNN, an RNN, an LSTM, and a BRDNN.

Alternatively, the encoder of the synthesizer 1300 may divide an input text into a plurality of short texts and may generate a plurality of text embedding vectors in correspondence to the respective short texts.

The decoder of the synthesizer 1300 may receive a speaker embedding vector and a text embedding vector as inputs from the speaker encoder 210. Alternatively, the decoder of the synthesizer 1300 may receive a speaker embedding vector as an input from the speaker encoder 210 and may receive a text embedding vector as an input from the encoder of the synthesizer 1300.

The decoder of the synthesizer 1300 may generate a spectrogram corresponding to the input text by inputting the speaker embedding vector and the text embedding vector into an artificial neural network model. In other words, the decoder of the synthesizer 1300 may generate a spectrogram for the input text in which the speech characteristics of a speaker are reflected. For example, the spectrogram may correspond to a mel-spectrogram, but is not limited thereto.

A spectrogram is a graph that visualizes the spectrum of a speech signal. The x-axis of the spectrogram represents time, the y-axis represents frequency, and values of respective frequencies per time may be expressed in colors according to the sizes of the values. The spectrogram may be a result of performing a short-time Fourier transformation (STFT) on a continuous speech signal (consecutive speech signals?).

The STFT is a method of dividing a speech signal into sections of a certain length and applying a Fourier transformation to each section. In this case, since a result of performing the STFT on a speech signal is a complex value, phase information may be lost by taking an absolute value for the complex value, and a spectrogram including only magnitude information may be generated.

On the other hand, the mel-spectrogram is a result of re-adjusting a frequency interval of the spectrogram to a mel-scale. Human auditory organs are more sensitive in a low frequency band than in a high frequency, and the mel-scale expresses the relationship between physical frequencies and frequencies actually perceived by a person by reflecting the characteristic. A mel-spectrogram may be generated by applying a filter bank based on the mel-scale to a spectrogram.

Meanwhile, although not shown in FIG. 13, the synthesizer 1300 may further include an attention module for generating an attention alignment. The attention module is a module that learns to which output from among outputs of all time-steps an output of a specific time-step of a decoder is most related. A higher quality spectrogram or mel-spectrogram may be output by using the attention module.

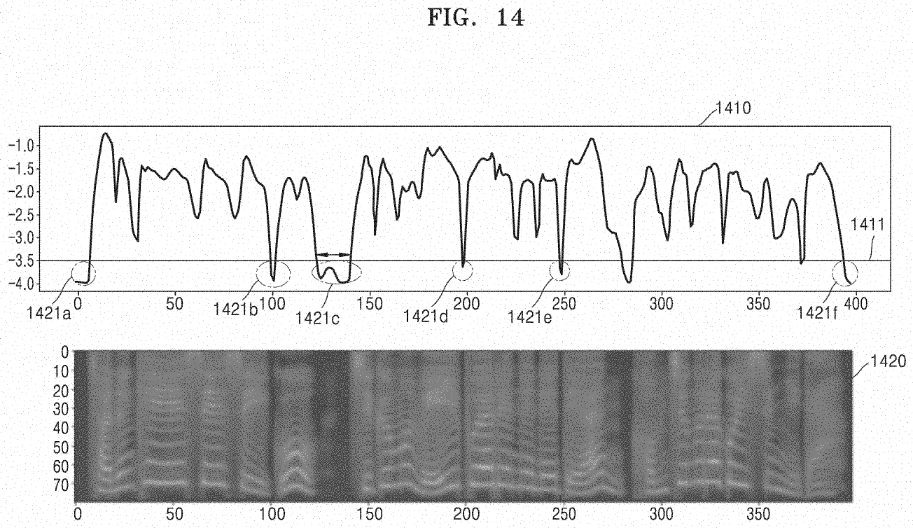

FIG. 14 is a diagram showing a volume graph corresponding to a mel-spectrogram.

A mel-spectrogram 1420 may include a plurality of frames. Referring to FIG. 14, a mel-spectrogram 1420 may include 400 frames. A processor may generate a volume graph 1410 by calculating the average energy of each frame. In frames of the mel-spectrogram 1420, portions with a dark color (e.g., yellow portions) have high volume values. The volume graph 1410 generated from the mel-spectrogram 1420 has a maximum value of 4.0 and a minimum value of −4.0.

The larger the average energy of a frame, the larger the volume value is. The smaller the average energy of a frame, the smaller the volume value is. In other words, a frame having a small average energy may correspond to a silent portion.

The processor may determine a silent portion in the mel-spectrogram 1420. The processor may generate the volume graph 1410 by calculating a volume value for each of a plurality of frames constituting the mel-spectrogram 1420.

The processor may select at least one frame whose volume value is less than or equal to a first threshold value 1411 from among the plurality of frames as first sections 1421a to 1421f.

In an embodiment, the processor may determine the first sections 1421a to 1421f as silent portions of the mel-spectrogram 1420. For example, the first threshold value 1411 may be −3.0, 3.25, 3.5, 3.75, etc., but is not limited thereto. The first threshold value 1411 may be set differently depending on how much noise is included in the mel-spectrogram 1420. In the case of the mel-spectrogram 1420 with a large amount of noise, the first threshold value 1411 may be set to a larger value.

In another embodiment, the processor may select sections in which the number of frames is equal to or greater than a second threshold value from among the first sections 1421a to 1421f as second sections 1421c and 1421e. The processor may determine the second sections 1421c and 1421e of the mel-spectrogram 1420 as silent portions. For example, the second threshold value may be 3, 4, 5, 6, 7, etc., but is not limited thereto. When a speech is generated by using the mel-spectrogram 1420, the second threshold value may be determined based on an overlap value and a hop size set in WaveRNN, which is one of vocoders. An overlap refers to the length of crossfading between batches when speech data is generated in the WaveRNN. For example, when an overlap value is 1200 and a hop size is 300, the second threshold value may be set to 4 or 5, because it is preferable that volume values of four consecutive frames are less than or equal to the first threshold value 1411.

Referring to FIG. 14, the processor may determine a section [[123, 132, 141], [280, 283, 286]] of the mel-spectrogram 1420 as a silent portion. The list represents [start point of a silent portion, a middle value, the end of the silent portion]. Meanwhile, even when the volume values of frames included in a first first section 1421a are less than or equal to the first threshold value 1411 and the number of the frames is equal to or greater than the second threshold value, the first first section 1421a is a section in which a speech starts, and thus the first first section 1421a may be excluded from silent portions. However, when generating speech data from the mel-spectrogram 1420 later, the processor may set a point after the first first section 1421a as the starting point of a speech.

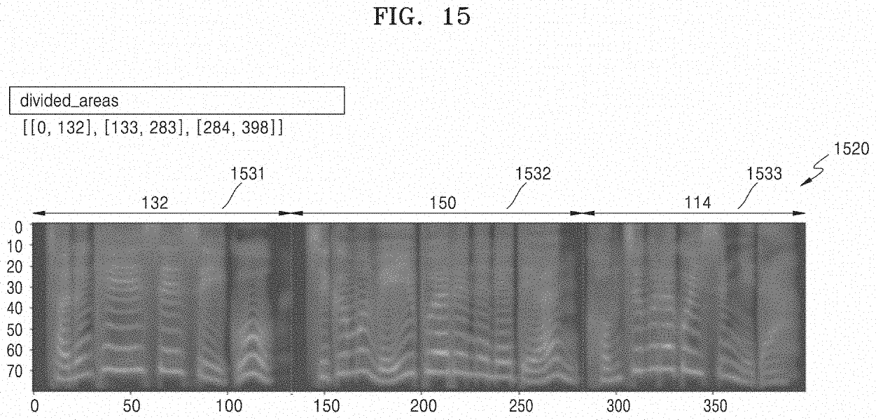

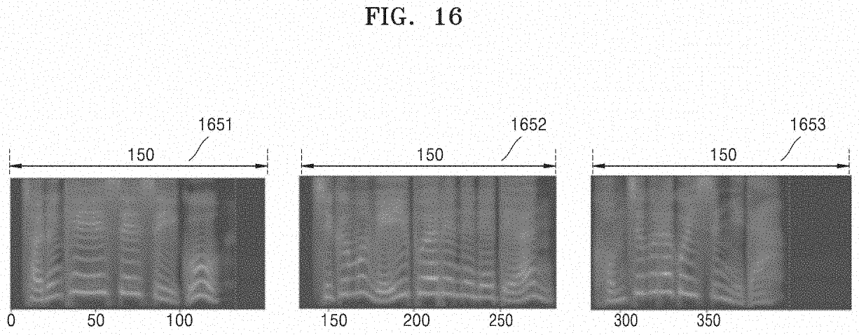

FIGS. 15 and 16 are diagrams for describing a process of dividing a mel-spectrogram into a plurality of sub mel-spectrograms.

A mel-spectrogram 1520 of FIG. 15 may correspond to the mel-spectrogram 1420 of FIG. 14.

A processor may divide the mel-spectrogram 1520 into a plurality of sub mel-spectrograms 1531, 1532, and 1533 based on the second sections 1421c and 1421e determined as the silent portion in FIG. 14. When a first second section 1421c is [123, 132, 141] and a second second section 1421e is [280, 283, 286], the processor may determine the intermediate value of the first second section 1421c as a first division point and determine the intermediate value of the second second section 1421e as a second division point.

The processor may generate the plurality of sub mel-spectrograms 1531, 1532, and 1533 by dividing the mel-spectrogram 1520 based on the first division point and the second division point.

The processor may calculate the length of each of the plurality of sub mel-spectrograms 1531, 1532, and 1533. Since the processor divides the mel-spectrogram 1520 into a plurality of sub mel-spectrograms 1531, 1532, and 1533 based on the silent portions of the mel-spectrogram 1520, the plurality of sub mel-spectrograms 1531, 1532, 1533 may have different lengths from one another.

Referring to FIG. 15, a first sub mel-spectrogram 1531 has a length of 132 corresponding to a section [0, 132], a second sub mel-spectrogram 1532 has a length of 150 corresponding to a section [133, 283], and a third sub mel-spectrogram 1533 has a length of 114 corresponding to a section [284, 398].

Referring to FIG. 16, the processor may post-process the plurality of sub mel-spectrograms 1531, 1532, and 1533, such that lengths of the plurality of sub mel-spectrograms 1531, 1532, and 1533 become identical to a reference batch length. In an embodiment, the reference batch length may be a preset value.

In another embodiment, the reference batch length may be set as the length of the longest sub mel-spectrogram from among the plurality of sub mel-spectrograms 1531, 1532, and 1533. For example, when the length of the first sub mel-spectrogram 1531 is 132, the length of the second sub mel-spectrogram 1532 is 150, and the length of the third sub mel-spectrogram 1533 is 114, the reference batch length may be set to 150.

The processor may apply zero-padding for sub mel-spectrograms having lengths less than the reference batch length, such that the lengths of the plurality of sub mel-spectrograms 1531, 1532, and 1533 become identical to the reference batch length. For example, when the reference batch length is set to 150, the processor may apply zero-padding for the first sub mel-spectrogram 1531 and the third sub mel-spectrogram 1533.

Referring to FIG. 16, a plurality of post-processed sub mel-spectrograms 1651, 1652, and 1653 all have the same length (e.g., 150).

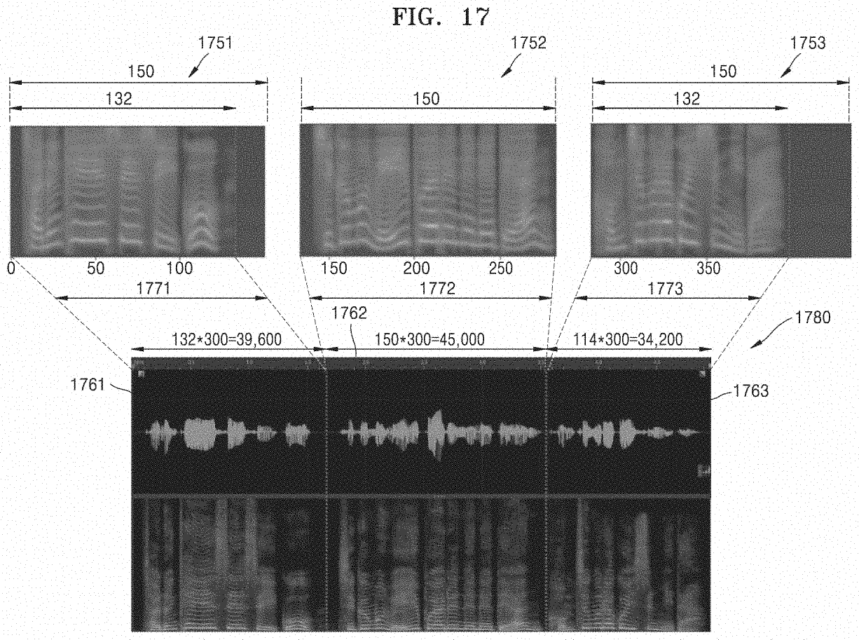

FIG. 17 is a diagram for describing a process of generating speech data from a plurality of sub mel-spectrograms.

Referring to FIG. 17, a plurality of post-processed sub mel-spectrograms 1751, 1752, and 1753 all have the same length (e.g., 150). The plurality of post-processed sub mel-spectrograms 1751, 1752, and 1753 of FIG. 17 may correspond to the plurality of post-processed sub mel-spectrograms 1651, 1652, and 1653 of FIG. 16, respectively.

A processor may generate a plurality of sub-speech data 1761, 1762, and 1763 from the plurality of post-processed sub mel-spectrograms 1751, 1752, and 1753, respectively. For example, the processor may generate the plurality of sub-speech data 1761, 1762, and 1763 from the plurality of post-processed sub mel-spectrograms 1751, 1752, and 1753 by using an ISFT or the Griffin-Lim algorithm, respectively.

In an embodiment, the processor may determine reference sections 1771, 1772, and 1773 regarding the plurality of sub-speech data 1761, 1762, and 1763 based on lengths of the plurality of sub mel-spectrograms 1531, 1532, and 1533 prior to post-processing, respectively.

For example, although the plurality of post-processed sub mel-spectrograms 1751, 1752, and 1753 all have the length of 150, the first sub mel-spectrogram 1531 corresponding to a first post-processed sub mel-spectrogram 1751 has the length of 132, the first post-processed sub mel-spectrogram 1751 includes data that is only effective up to the length of 132. For the same reason, a third post-processed sub mel-spectrogram 1753 may include data only effective up to the length of 114, whereas a second post-processed sub mel-spectrogram 1752 may include data effective for the entire length of 150.

The processor may determine the length of a first reference section 1771 of first sub-speech data 1761 generated from the first post-processed sub mel-spectrogram 1751 to 132, determine the length of a second reference section 1772 of second sub-speech data 1762 generated from the second post-processed sub mel-spectrogram 1752 to 150, and determine the length of a third reference section 1773 of third sub-speech data 1763 generated from the third post-processed sub mel-spectrogram 1753 to 114.

The processor may generate speech data 1780 by connecting the first reference section 1771, the second reference section 1772, and the third reference section 1773.

The processor may generate speech data from a plurality of sub mel-spectrograms based on respective lengths of the plurality of sub mel-spectrograms and a pre-set hop size. In detail, the processor may determine the respective reference sections 1771, 1772, and 1773 for the plurality of sub-speech data 1761, 1762, and 1763 by multiplying the respective lengths of the plurality of sub mel-spectrograms and a hop size (e.g., 300) corresponding to the length of speech data covered by one frame of a mel-spectrogram.

Meanwhile, the processor described above with reference to FIGS. 14 to 17 may be hardware included in a vocoder of a speech synthesis system and/or separate independent hardware.

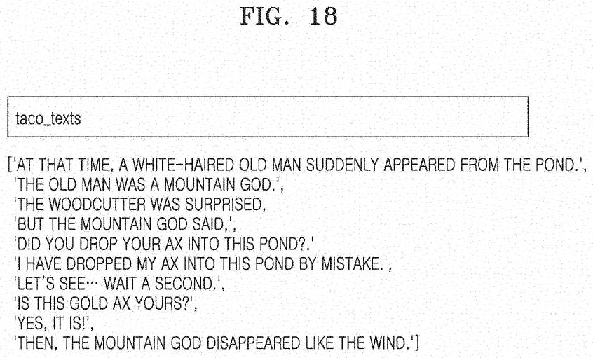

FIG. 18 is a diagram for describing an example of dividing a text sequence.

FIG. 18 shows an example of a text sequence composed of a particular natural language. Also, punctuation marks are included in the text sequence. For example, the punctuation marks may be ‘.’, ‘,’, ‘?’, ‘!’, etc.

The speech synthesis systems 100 and 200 identify characters and punctuation marks included in a text sequence. Next, the speech synthesis systems 100 and 200 check whether punctuation marks included in the text sequence correspond to predetermined punctuation marks.

When the punctuation marks correspond to the predetermined punctuation marks, the speech synthesis systems 100 and 200 may divide the text sequence based on the punctuation marks. For example, when punctuation marks ‘.’, ‘,’, ‘?’, and ‘!’ are predetermined punctuation marks, the speech synthesis systems 100 and 200 may generate sub-sequences by dividing the text sequence based on pre-set punctuation marks.

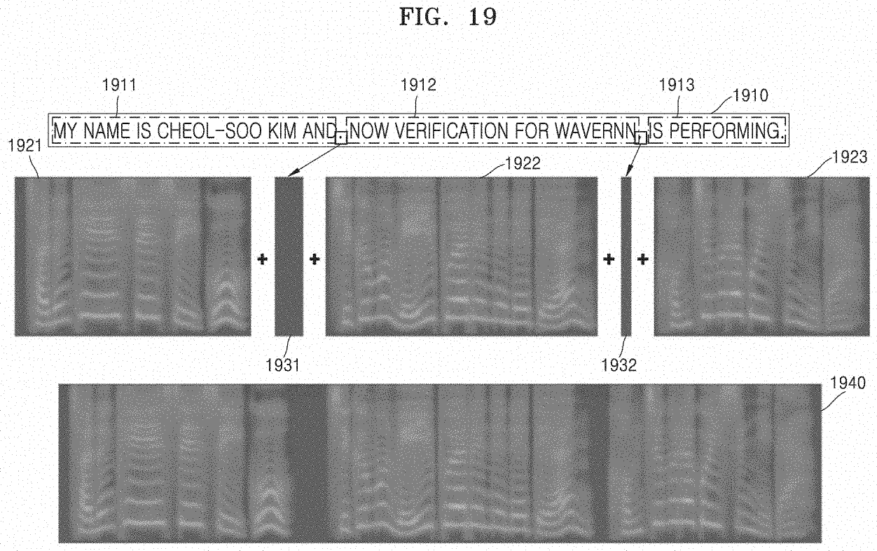

FIG. 19 is a diagram for describing a process of generating a final mel-spectrogram by adding a silent mel-spectrogram between sub mel-spectrograms.

Referring to FIG. 19, the speech synthesis systems 100 and 200 may divide a text sequence 1910 into a plurality of sub-sequences 1911, 1912, and 1913. Since the method of dividing the text sequence 1910 into the plurality of sub-sequences 1911, 1912, and 1913 has been described above with reference to FIG. 18, detailed descriptions thereof will be omitted below.

The speech synthesis systems 100 and 200 may generate a plurality of sub mel-spectrograms 1921, 1922, and 1923 by using the plurality of sub-sequences 1911, 1912, and 1913. In detail, the speech synthesis systems 100 and 200 may generate the plurality of sub mel-spectrograms 1921, 1922, and 1923 based on the plurality of sub-sequences 1911, 1912, and 1913 corresponding to texts and speaker information. Also, the speech synthesis systems 100 and 200 may generate speech data from the plurality of sub mel-spectrograms 1921, 1922, and 1923. Since detailed descriptions thereof have been given above with reference to FIGS. 1 to 3, detailed descriptions thereof will be omitted below.

In an embodiment, the speech synthesis systems 100 and 200 may generate a final mel-spectrogram 1940 by adding silent mel-spectrograms 1931 and 1932 between the plurality of sub mel-spectrograms 1921, 1922, and 1923. The speech synthesis systems 100 and 200 may generate speech data from the final mel-spectrogram 1940.

In detail, the speech synthesis systems 100 and 200 may identify last characters of the plurality of sub-sequences 1911, 1912, and 1913 (i.e., texts) corresponding to the plurality of sub mel-spectrograms 1921, 1922, and 1923, respectively. When the last characters are first group characters, the speech synthesis systems 100 and 200 may generate a final mel-spectrogram by adding a silent mel-spectrogram having a first time to a sub mel-spectrogram. Also, when the last characters are second group characters, the speech synthesis systems 100 and 200 may generate a final mel-spectrogram by adding a silent mel-spectrogram having a second time to a sub mel-spectrogram.

For example, the first group characters are characters corresponding to a short pause period and may include ‘,’ and ‘ ’. Also, the second group characters are characters corresponding to a long pause period and may include ‘.’, ‘?’, and ‘!’. In this case, the first time may be set to a reference time, and the second time may be set to three times the reference time.

Meanwhile, the speech synthesis systems 100 and 200 may divide characters of the plurality of sub-sequences 1911, 1912, and 1913 into two or more groups, and a time of a silent mel-spectrogram corresponding to each group is also not limited to the above-stated examples.

In another embodiment, the speech synthesis systems 100 and 200 may generate a final mel-spectrogram by adding a breath sound mel-spectrogram between the plurality of sub mel-spectrograms 1921, 1922, and 1923. To this end, the speech synthesis systems 100 and 200 may obtain breath sound data as speaker information.

In another embodiment, the speech synthesis systems 100 and 200 may identify last characters of the plurality of sub-sequences 1911, 1912, and 1913 (i.e., texts) corresponding to the plurality of sub mel-spectrograms 1921, 1922, and 1923, respectively. When the last characters are first group characters, the speech synthesis systems 100 and 200 may generate a final mel-spectrogram by adding a silent mel-spectrogram having a predetermined time to a sub mel-spectrogram. Also, when the last characters are second group characters, the speech synthesis systems 100 and 200 may generate a final mel-spectrogram by adding a breath sound mel-spectrogram to a sub mel-spectrogram. For example, the first group characters are characters corresponding to a short pause period and may include ‘,’ and ‘ ’. Also, the second group characters are characters corresponding to a long pause period and may include ‘.’, ‘?’, and ‘!’.

In another embodiment, the speech synthesis systems 100 and 200 may also generate a final mel-spectrogram by adding a silent mel-spectrogram having an arbitrary time between the plurality of sub mel-spectrograms 1921, 1922, and 1923.

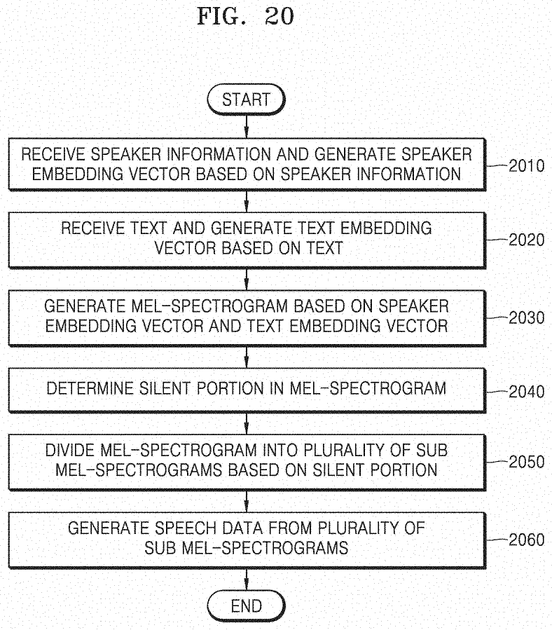

FIG. 20 is a flowchart of a method of determining a silent portion of a mel-spectrogram according to an example embodiment.

Referring to FIG. 20, in operation 2010, a processor may receive speaker information and generate a speaker embedding vector based on the speaker information.

The speaker information may correspond to a speech signal or a speech sample of a speaker. The processor may receive a speech signal or a speech sample of a speaker, extract speech characteristics of the speaker, and represent the same as an embedding vector.

The speech characteristics may include at least one of various factors, such as a speech speed, a pause period, a pitch, a tone, a prosody, an intonation, and an emotion. In other words, the processor may represent discontinuous data values included in the speaker information as a vector including consecutive numbers. For example, the processor may generate a speaker embedding vector based on at least one of or a combination of two or more of various artificial neural network models, such as a pre-net, a CBHG module, a deep neural network (DNN), a convolutional neural network (CNN), a recurrent neural network (RNN), a long short-term memory network (LSTM), and a bidirectional recurrent deep neural network (BRDNN). In an embodiment, operation 2010 may be performed by the speaker encoder 210 of FIG. 2.

In operation 2020, the processor may receive a text and generate a text embedding vector based on the text.

A text may include a sequence of characters in a particular natural language. For example, a sequence of characters may include alphabetic characters, numbers, punctuation marks, or other special characters.

The processor may divide an input text into letters, characters, or phonemes and input the divided text into an artificial neural network model. For example, the processor may generate a text embedding vector based on at least one of or a combination of two or more of various artificial neural network models, such as a pre-net, a CBHG module, a DNN, a CNN, an RNN, an LSTM, and a BRDNN.

Alternatively, the processor may divide an input text into a plurality of short texts and may generate a plurality of text embedding vectors in correspondence to the respective short texts. In an embodiment, operation 2020 may be performed by the synthesizer 220 of FIG. 2.

In operation 2030, the processor may generate a mel-spectrogram based on the speaker embedding vector and the text embedding vector.

The processor may receive a speaker embedding vector and a text embedding vector as inputs. The processor may generate a spectrogram corresponding to the input text by inputting the speaker embedding vector and the text embedding vector into an artificial neural network model. In other words, the processor may generate a spectrogram for the input text in which the speech characteristics of a speaker are reflected. For example, the spectrogram may correspond to a mel-spectrogram, but is not limited thereto.

A spectrogram is a graph that visualizes the spectrum of a speech signal. The x-axis of the spectrogram represents time, the y-axis represents frequency, and values of respective frequencies per time may be expressed in colors according to the sizes of the values. The spectrogram may be a result of performing a short-time Fourier transformation (STFT) on a continuous speech signal (consecutive speech signals?). On the other hand, the mel-spectrogram is a result of re-adjusting a frequency interval of the spectrogram to a mel-scale. In an embodiment, operation 2030 may be performed by the synthesizer 220 of FIG. 2.

In operation 2040, the processor may determine a silent portion in a mel-spectrogram.

The processor may generate a volume graph by calculating a volume value for each of a plurality of frames constituting the mel-spectrogram. The processor may select at least one frame whose volume value is less than or equal to a first threshold value from among the plurality of frames as first sections. In an embodiment, the processor may determine first sections as silent portions of a mel-spectrogram.

In another embodiment, the processor may select a section in which the number of frames is equal to or greater than a second threshold from among the first sections as a second section. The processor may determine the second section of the mel-spectrogram as a silent portion. For example, when a speech is generated by using the mel-spectrogram 1420, the second threshold value may be determined based on an overlap value and a hop size set in WaveRNN, which is one of vocoders.

In operation 2050, the processor may divide a mel-spectrogram into a plurality of sub mel-spectrograms based on a silent portion.

The processor may calculate the length of each of the plurality of sub mel-spectrograms. The processor may post-process the plurality of sub mel-spectrograms, such that the lengths of the plurality of sub mel-spectrograms become identical to a reference batch length. In an embodiment, the reference batch length may be a preset value. In another embodiment, the length of the longest sub mel-spectrogram from among the plurality of sub mel-spectrograms may be set to the reference batch length.

The processor may generate speech data from a plurality of post-processed sub mel-spectrograms. The processor may apply zero-padding to sub mel-spectrograms having lengths less than the reference batch length, such that the lengths of the plurality of sub mel-spectrograms become identical to the preset batch length. Therefore, the plurality of sub mel-spectrograms may be post-processed.

In operation 2060, the processor may generate speech data from the plurality of sub mel-spectrograms.

The processor may generate a plurality of speech data from the plurality of post-processed sub mel-spectrograms, respectively. The processor may determine a reference section for each of the plurality of sub speech data based on the length of each of the plurality of sub mel-spectrograms.

The processor may generate speech data from a plurality of sub mel-spectrograms based on respective lengths of the plurality of sub mel-spectrograms and a pre-set hop size. In detail, the processor may determine respective reference sections for the plurality of sub-speech data by multiplying the respective lengths of the plurality of sub mel-spectrograms and a hop size corresponding to the length of speech data covered by one frame of a mel-spectrogram.

The processor may generate speech data by connecting the reference sections.

As described above with reference to FIGS. 2 and 3, the synthesizers 220 and 300 may generate an attention alignment. In detail, attention alignments may be generated in correspondence to spectrograms (or mel-spectrograms), respectively. For example, when the synthesizers 220 and 300 generate a total of x spectrograms (or mel-spectrograms), attention alignments may be generated corresponding to the x spectrograms, respectively. Accordingly, the quality of corresponding spectrograms (or mel-spectrograms) may be determined through attention alignments.

The synthesizers 220 and 300 according to an example embodiment may generate a plurality of spectrograms (or mel-spectrograms) for a single input pair consisting of an input text and a speaker embedding vector. Also, the synthesizers 220 and 300 may calculate a score of an attention alignment corresponding to each of the plurality of spectrograms (or mel-spectrograms). Therefore, the synthesizers 220 and 300 may select any one of the plurality of spectrograms (or mel-spectrograms) based on calculated scores. Here, a selected spectrogram (or mel-spectrogram) may represent the highest quality synthesized speech for a single input pair.

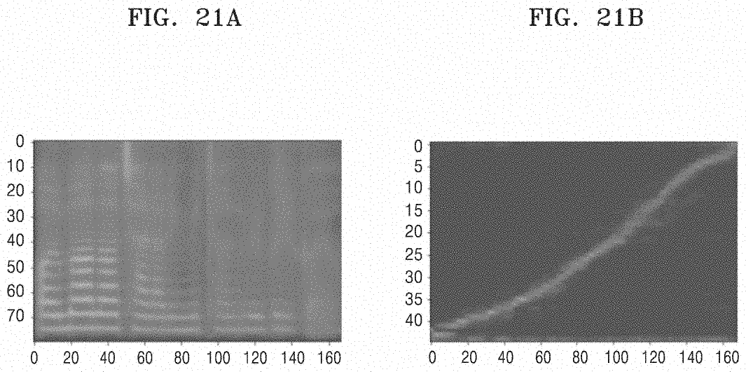

Hereinafter, examples in which the synthesizers 220 and 300 calculate scores of attention alignments will be described with reference to FIGS. 21 to 30. Hereinafter, it will be described that the synthesizers 220 and 300 calculate scores of the attention alignments, but a module for calculating the scores of the attention alignments may not be the synthesizers 220 and 300. For example, the scores of the attention alignments may be calculated by a separate module included in the speech synthesis system 200 or another module separated from the speech synthesis system 200.

Also, hereinafter, a spectrogram and a mel-spectrogram will be described as terms that may be used interchangeably with each other. In other words, even when the term spectrogram is used in the descriptions below, it may be replaced with the term mel-spectrogram. Also, even when the term mel-spectrogram is used in the descriptions below, it may be replaced with the term spectrogram.

FIGS. 21A and 21B are diagrams showing an example of a mel-spectrogram and an attention alignment.

FIG. 21A shows an example of a mel-spectrogram generated by the synthesizers 220 and 300 according to a certain input pair (an input text and a speaker embedding vector). Also, FIG. 21B shows an attention alignment corresponding to the mel-spectrogram of FIG. 21A.

For example, when an amount of data is not large or sufficient learning is not performed, the synthesizers 220 and 300 may not be able to generate a high-quality mel-spectrogram. Attention alignment may be interpreted as a history of every moment that the synthesizers 220 and 300 concentrate on generation of a mel-spectrogram.

For example, when a line representing the attention alignment is dark and there is little noise, it may be interpreted that the synthesizers 220 and 300 confidently performed inference at every moment of generation of a mel-spectrogram. In other words, in the case of the example, it may be determined that the synthesizers 220 and 300 have generated a high-quality mel-spectrogram. Therefore, the quality of the attention alignment (e.g., a degree to which the color of the attention alignment is dark, a degree to which the outline of the attention alignment is clear, etc.) may be used as a very important index for estimating an inference quality of the synthesizers 220 and 300.

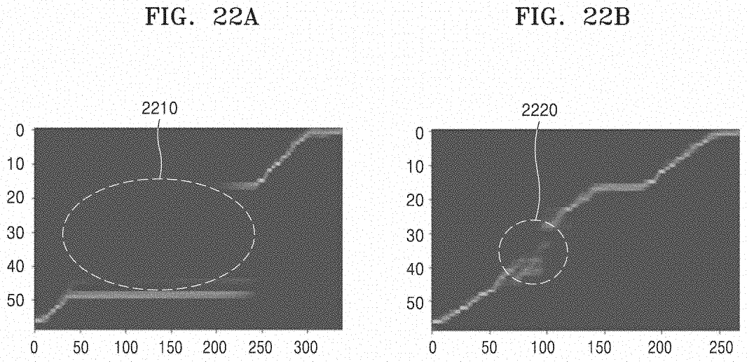

FIGS. 22A and 22B are diagrams for describing the quality of an attention alignment.

FIG. 22A and 22B show attention alignments corresponding to the same input pair (an input text and a speaker embedding vector).

FIG. 22A shows an example in which a middle portion 2210 of an attention alignment is not generated. In other words, according to the attention alignment of FIG. 22A, it may be interpreted that the quality of a mel-spectrogram corresponding thereto is low.

FIG. 22B shows an attention alignment having a relatively better quality as compared to the attention alignment of FIG. 22A. In other words, it may be interpreted that a mel-spectrogram corresponding to the attention alignment of FIG. 22B has higher quality than the mel-spectrogram corresponding to the attention alignment of FIG. 22A. However, even in the case of the attention alignment of FIG. 22B, since an unclear portion is included in a middle portion 2220, it may be interpreted that the quality of the mel-spectrogram is not very high.

When the attention alignments shown in FIGS. 22A and 22B are generated, it needs to be determined that the quality of the corresponding mel-spectrograms is not high. The synthesizers 220 and 300 according to an embodiment determine the quality of an attention alignment based on a score of the attention alignment. In other words, the synthesizers 220 and 300 may determine the quality of a mel-spectrogram according to the score of the corresponding attention alignment.

For example, the synthesizers 220 and 300 may calculate an encoder score and a decoder score of an attention alignment. Next, the synthesizers 220 and 300 may calculate a total score of the attention alignment by combining the encoder score and the decoder score.

The quality of an attention alignment may be determined based on any one of an encoder score, a decoder score, and a total score. Therefore, the synthesizers 220 and 300 may calculate any one of an encoder score, a decoder score, and a total score as needed.

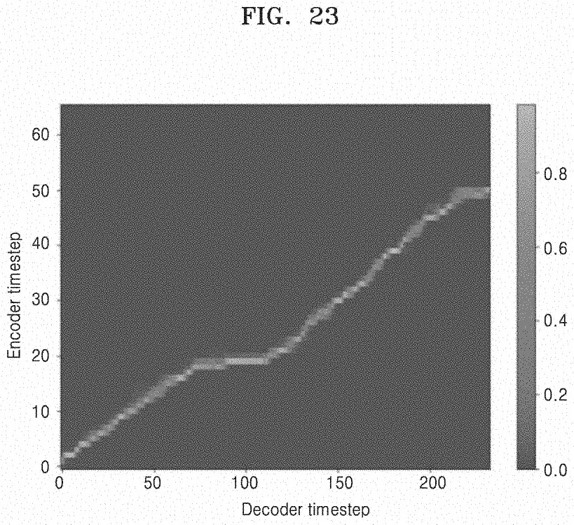

FIG. 23 is a diagram for describing coordinate axes representing an attention alignment and the quality of the attention alignment.

Referring to FIG. 23, an attention alignment is shown in 2-dimensional coordinates. In this case, the horizontal axis of the 2-dimensional coordinates represents a decoder timestep, and the vertical axis represents an encoder timestep. In other words, the 2-dimensional coordinates in which an attention alignment is expressed indicates a portion to be focused on when the synthesizers 220 and 300 generate a mel-spectrogram.

The decoder time step refers to a time invested by the synthesizers 220 and 300 to utter each of the phonemes included in an input text. The decoder timesteps are arranged at a time interval corresponding to a single hop size, and a single hop size refers to 1/80 seconds.

The encoder timestep corresponds to phonemes included in the input text. For example, when the input text is ‘first sentence’, the encoder timestep may include ‘f’, ‘i’, ‘r, ‘s, ‘t, ‘s, ‘e, ‘n, ‘t, ‘e, ‘n, ‘c, and ‘e’.

Referring to FIG. 23, each of the points constituting an attention alignment is expressed in a particular color. Here, a color may be matched with a particular value corresponding thereto. For example, each of colors constituting an attention alignment is a value representing a probability distribution and may be a value between 0 and 1.

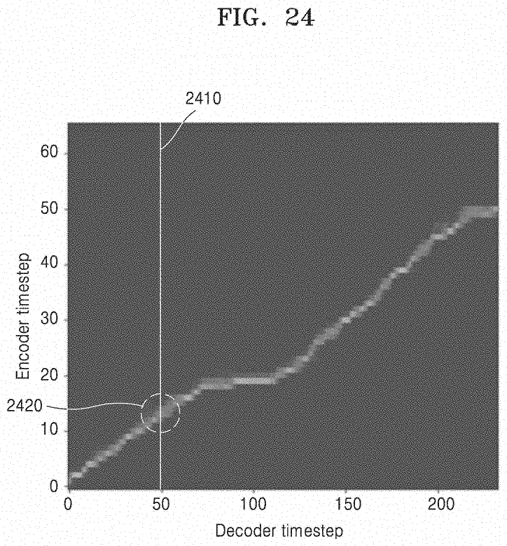

FIG. 24 is a diagram for describing an example in which a synthesizer calculates an encoder score.

Referring to FIG. 24, values 2410 corresponding to ‘50’ of a decoder timestep in an attention alignment are shown. Since an attention alignment is transposed by recording each softmax result value, a sum of values corresponding to a single step constituting the decoder timestep is 1. In other words, the sum of all of the values 2410 of FIG. 24 is 1.

Meanwhile, referring to upper a values 2420 from among the values 2410, a phoneme on which the synthesizers 220 and 300 are focusing to generate a mel-spectrogram at a time point corresponding to ‘50’ of the decoder timestep may be determined. Therefore, the synthesizers 220 and 300 may calculate an encoder score for each step constituting a decoder timestep, thereby checking whether a mel-spectrogram properly represents an input text (i.e., the quality of the mel-spectrogram).

For example, the synthesizers 220 and 300 may calculate an encoder score based on Equation 1 below

$${encoder\_score}_{s} = {\sum }_{i = 1}^{n} max ( {align}_{decoder} , s , i ) \qquad [ Equation 1 ]$$

In Equation 1, max(align_{decoder}, s, i) represents an i-th upper value of an s-th step based on a decoder timestep in an attention alignment align_{decoder} (s and i are natural numbers equal to or greater than 1).

In other words, the synthesizers 220 and 300 extract n values from values at the s-th step of the decoder timestep (n is a natural number equal to or greater than 2). Here, the n values may indicate upper n values at the s-th step.

Next, the synthesizers 220 and 300 calculate an s-th score encoder_scoreₛ at the s-th step by using extracted n values. For example, the synthesizers 220 and 300 may calculate the s-th score encoder_scoreₛ by summing the extracted n values.

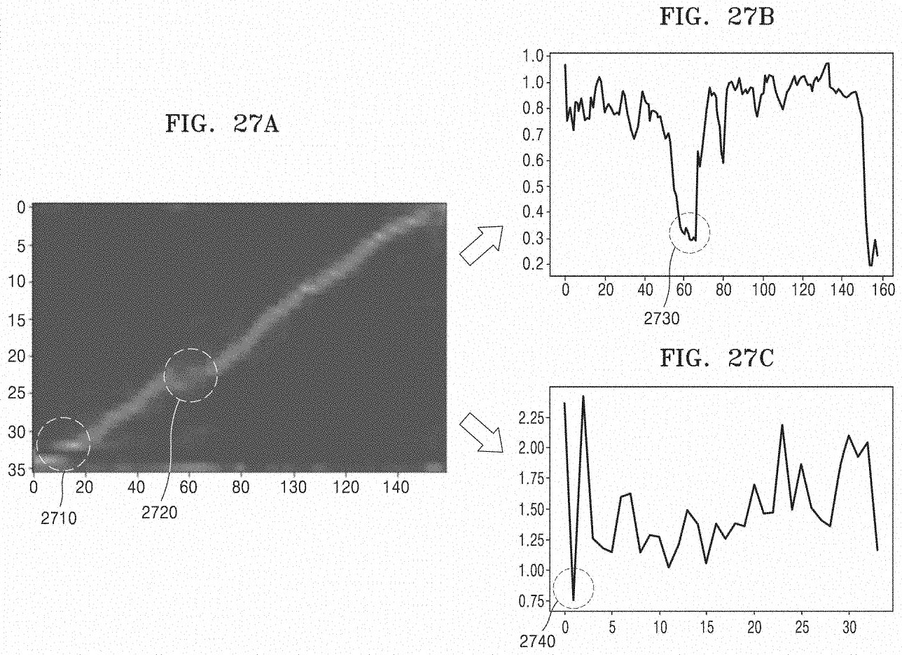

In this regard, the synthesizers 220 and 300 calculate encoder scores from a step corresponding to the beginning of a spectrogram to a step corresponding to the end of the spectrogram in a decoder timestep. Also, the synthesizers 220 and 300 may compare calculated encoder scores with a predetermined value to evaluate the quality of a mel-spectrogram. An example in which the synthesizers 220 and 300 evaluate the quality of a mel-spectrogram based on encoder scores will be described later with reference to FIGS. 27A-27C.

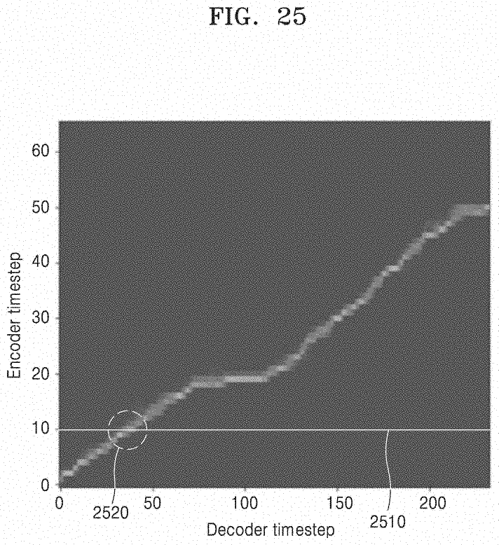

FIG. 25 is a diagram for describing an example in which a synthesizer calculates a decoder score.

Referring to FIG. 25, values 2510 corresponding to ‘10’ of a decoder timestep in an attention alignment are shown. Also, upper b values 2520 from among the values 2510 are shown.

As described above with reference to FIG. 24, encoder scores are calculated from values at each step constituting the decoder timestep. On the other hand, decoder scores are calculated from values at each step constituting the decoder timestep. The purposes of encoder scores and decoder scores are different. In detail, an encoder score is an index for determining whether an attention module has well determined a phoneme that needs to be focused on every hour. On the other hand, a decoder score is an index for determining whether an attention module has well focused on a particular phoneme constituting an input text without omitting time allocation

$${decoder\_score}_{s} = {\sum }_{i = 1}^{m} max ( {align}_{encoder} , s , i ) \qquad [ Equation 2 ]$$

In Equation 1, max(align_{encoder}, s, i) represents an i-th upper value of an s-th step based on an encoder timestep in an attention alignment align_{encoder} (s and i is a natural number equal to or greater than 1).

In other words, the synthesizers 220 and 300 extract m values from values at the s-th step of the encoder timestep (m is a natural number equal to or greater than 2). Here, the m values may indicate upper m values at the s-th step.

Next, the synthesizers 220 and 300 calculate an s-th score decoder_scoreₛ at the s-th step by using extracted m values. For example, the synthesizers 220 and 300 may calculate the s-th score decoder_scoreₛ by summing the extracted m values.

In this regard, the synthesizers 220 and 300 calculates decoder scores from a step corresponding to the beginning of a spectrogram to a step corresponding to the end of the spectrogram in an encoder timestep. Also, the synthesizers 220 and 300 may compare calculated decoder scores with a predetermined value to evaluate the quality of a mel-spectrogram. An example in which the synthesizers 220 and 300 evaluate the quality of a mel-spectrogram based on decoder scores will be described later with reference to FIGS. 27A-27C.

In other words, the decoder score is calculated as a value obtained by summing the upper m values in an encoder timestep in an attention alignment. This may become an indicator of how much energy a speech synthesis system has spent for speaking each of phonemes constituting an input text.

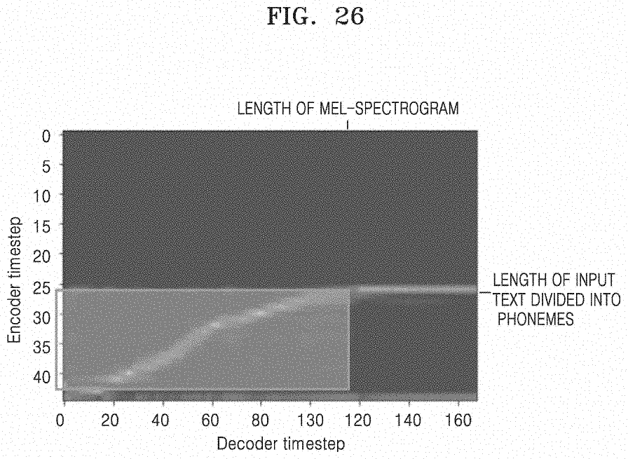

FIG. 26 is a diagram for describing an example of extracting a portion having a valid meaning from an attention alignment.

The length of a decoder timestep is the same as the length of a mel-spectrogram. Therefore, a portion of an attention alignment having a valid meaning corresponds to the length of the mel-spectrogram.

Meanwhile, an encoder timestep corresponds to lengths of phonemes constituting an input text. Therefore, a portion of the attention alignment having a valid meaning corresponds to a length corresponding to a result of decomposing a text into phonemes.

FIGS. 27A-27C are diagrams for describing a relationship between the quality of an attention alignment, an encoder score, and a decoder score.

FIG. 27A indicates an attention alignment, FIG. 27B indicates an encoder score of the attention alignment of FIG. 27A, and FIG. 27C indicates a decoder score of the attention alignment of FIG. 27A.

Referring to FIG. 27A, it may be seen that the quality of the attention alignment is low in a first portion 2710 and a second portion 2720. In detail, the first portion 2710 indicates that particular phoneme included in an input text is not focused, and the second portion 2720 indicates that no phoneme is clearly focused on at a particular time point at which a mel-spectrogram is generated.

Meanwhile, referring to FIG. 27B, it may be seen that an encoder score 2730 corresponding to the second portion 2720 is calculated as a low score. Also, referring to FIG. 27C, it may be seen that a decoder score 2740 corresponding to the first portion 2710 is calculated as a low score. In other words, the synthesizers 220 and 300 may compare a encoder score or a decoder score with a predetermined value (threshold value) to evaluate the quality of a mel-spectrogram.

Meanwhile, the synthesizers 220 and 300 may evaluate the quality of a mel-spectrogram by combining an encoder score and a decoder score.

For example, the synthesizers 220 and 300 may modify the encoder score of Equation 1 according to Equation 3 below, thereby calculating a final encoder score
encoder_score

$$encoder\_score = \frac{1}{l} {\sum }_{s = 1}^{{de}_{l}} {\sum }_{i = 1}^{n} max ( {align}_{decoder} , s , i ) \qquad [ Equation 3 ]$$

In Equation 3, deₗ denotes a frame length of a mel-spectrogram, and s denotes a decoder timestep. Other variables constituting Equation 3 are the same as those of Equation 1 described above.

Also, the synthesizers 220 and 300 may modify the encoder score of Equation 2 according to Equation 4 below, thereby calculating a final encoder score
decoder_score

$$decoder\_score = {\sum }_{j = 1}^{dl} min ( ( {ln ( {\sum }_{i = 1}^{m} max ( {align}_{encoder} , s , i ) )}_{s = 1}^{{en}_{l} - 1} , j ) \qquad [ Equation 4 ]$$

In Equation 4, min((x), y) represents a y-th smallest value (i.e., a lower y-th value) from among values constituting a set x, and represents an encoder timestep. dl represents the length of a decoder score and is the sum of all values up to the lower dl-th value.

Also, the synthesizers 220 and 300 may calculate a final score score according to Equation 5 below

score=encoder_score+0.1×decoder_score [Equation 5]

In Equation 5, 0.1 denotes a weight, and a value of the weight may be changed as needed.

As described above with reference to FIGS. 21 to 27, as the synthesizers 220 and 300 calculate scores (an encoder score, a decoder score, and a final score) of an attention alignment, the quality of a mel-spectrogram corresponding to the attention alignment may be determined. Therefore, the speech synthesis systems 100 and 200 may select a mel-spectrogram of the highest quality from among a plurality of mel-spectrograms. Accordingly, the speech synthesis systems 100 and 200 are capable of outputting a synthesized speech of the highest quality.

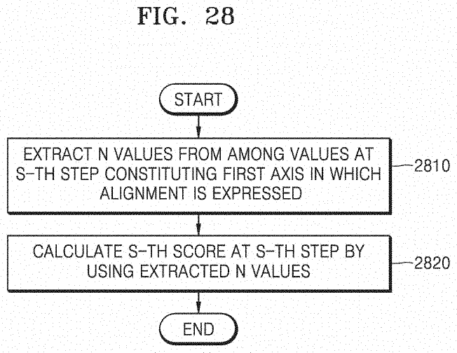

FIG. 28 is a flowchart of an example of a method of calculating an encoder score for an attention alignment.

Referring to FIG. 28, a method of calculating an encoder score includes operations processed in a time series by the speech synthesis systems 100 and 200 or the synthesizers 220 and 300 shown in FIGS. 1 to 3. Therefore, it is obvious that, even when omitted below, the descriptions given above with respect to the speech synthesis systems 100 and 200 or the synthesizers 220 and 300 shown in FIGS. 1 to 3 may also be applied to the method of calculating an encoder score of FIG. 28.

In operation 2810, the synthesizers 220 and 300 extract n values from values at an s-th step constituting a first axis in which an alignment is expressed. Here, n and s each indicates a natural number equal to or greater than 1. Also, the last value of s indicates a step corresponding to the end of a spectrogram. The first axis is a decoder timestep, and the decoder timestep refers to a timestep of a decoder included in the synthesizers 220 and 300 generating spectrograms. Also, a spectrogram corresponds to a verbal utterance of a sequence of characters composed of a particular natural language.

In operation 2820, the synthesizers 220 and 300 calculate an s-th score at the s-th step by using extracted n values. For example, the synthesizers 220 and 300 may extract upper n values from among values at the s-th step, and n indicates a natural number equal to or greater than 2.

Also, although not shown in FIG. 28, the synthesizers 220 and 300 may evaluate the quality of a spectrogram by comparing an s-th score with a predetermined value.

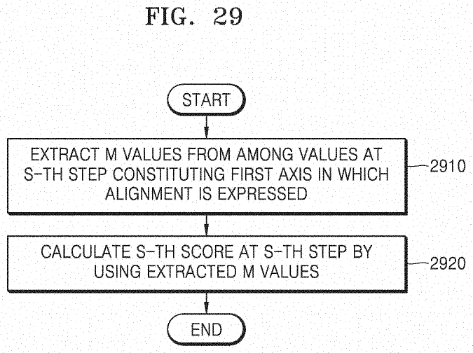

FIG. 29 is a flowchart of an example of a method of calculating a decoder score for an attention alignment.

Referring to FIG. 29, a method of calculating a decoder score includes operations processed in a time series by the speech synthesis systems 100 and 200 or the synthesizers 220 and 300 shown in FIGS. 1 to 3. Therefore, it is obvious that, even when omitted below, the descriptions given above with respect to the speech synthesis systems 100 and 200 or the synthesizers 220 and 300 shown in FIGS. 1 to 3 may also be applied to the method of calculating a decoder score of FIG. 29.

In operation 2910, the synthesizers 220 and 300 extract m values from values at an s-th step constituting a first axis in which an alignment is expressed. Here, m and s each indicates a natural number equal to or greater than 1. Also, the last value of s indicates a step corresponding to the end of a spectrogram. The first axis is an encoder timestep, and the encoder timestep refers to a timestep of an encoder included in the synthesizers 220 and 300 generating spectrograms. Also, a spectrogram corresponds to a verbal utterance of a sequence of characters composed of a particular natural language.

In operation 2920, the synthesizers 220 and 300 calculate an s-th score at the s-th step by using extracted m values. For example, the synthesizers 220 and 300 may extract upper m values from among values at the s-th step, and m indicates a natural number equal to or greater than 2.

Also, although not shown in FIG. 29, the synthesizers 220 and 300 may evaluate the quality of a spectrogram by comparing an s-th score with a predetermined value.

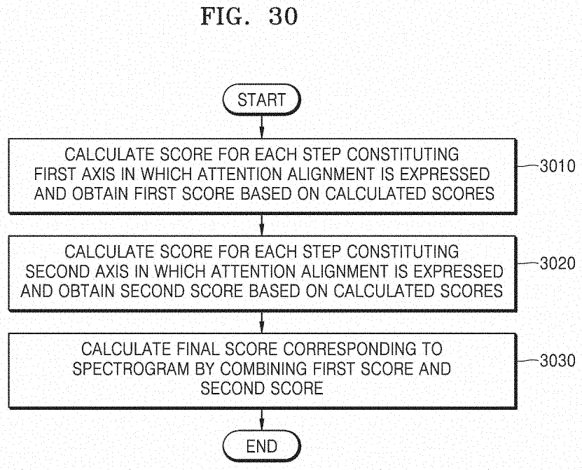

FIG. 30 is a flowchart of an example of a method of calculating a final score for an attention alignment.

Referring to FIG. 30, a method of calculating a final score includes operations processed in a time series by the speech synthesis systems 100 and 200 or the synthesizers 220 and 300 shown in FIGS. 1 to 3. Therefore, it is obvious that, even when omitted below, the descriptions given above with respect to the speech synthesis systems 100 and 200 or the synthesizers 220 and 300 shown in FIGS. 1 to 3 may also be applied to the method of calculating a final score of FIG. 30.

In operation 3010, the synthesizers 220 and 300 calculate scores for each of steps constituting the first axis in which an attention alignment is expressed and obtain a first score based on calculated scores. Here, the first axis refers to a decoder timestep.

The synthesizers 220 and 300 may calculate the first score by combining upper n scores from among the calculated scores. Here, n indicates a natural number equal to or greater than 1. For example, the synthesizers 220 and 300 may calculate the first score based on Equation 3.

In operation 3020, the synthesizers 220 and 300 calculate scores for each of steps constituting a second axis in which an attention alignment is expressed and obtain a second score based on calculated scores. Here, the second axis refers to an encoder timestep.

The synthesizers 220 and 300 may calculate the second score by combining lower m scores from among the calculated scores. Here, m indicates a natural number equal to or greater than 1. For example, the synthesizers 220 and 300 may calculate the second score based on Equation 4.

In operation 3030, the synthesizers 220 and 300 calculate a final score corresponding to a spectrogram by combining the first score and the second score.

The synthesizers 220 and 300 may calculate a final score by summing the second score to which a predetermined weight is applied and the first score. For example, the synthesizers 220 and 300 may calculate the final score based on Equation 5.

Also, although not shown in FIG. 30, the synthesizers 220 and 300 may evaluate the quality of a spectrogram by comparing the final score with a predetermined value.

The above descriptions of the present specification are for illustrative purposes only, and one of ordinary skill in the art to which the content of the present specification belongs will understand that embodiments of the present disclosure may be easily modified into other specific forms without changing the technical spirit or the essential features of the present disclosure. Therefore, it should be understood that the embodiments described above are illustrative and non-limiting in all respects. For example, each component described as a single type may be implemented in a distributed manner, and similarly, components described as being distributed may also be implemented in a combined form.

The scope of the present disclosure is indicated by the claims which will be described in the following rather than the detailed description of the exemplary embodiments, and it should be understood that the claims and all modifications or modified forms drawn from the concept of the claims are included in the scope of the present disclosure.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A speech synthesis system comprising:
an encoder configured to generate a speaker embedding vector corresponding to a verbal speech based on a first speech signal corresponding to a verbal utterance;
a synthesizer configured to perform at least once the cycle including generating of a plurality of spectrograms corresponding to verbal utterance of the sequence of the text based on the speaker embedding vector and a sequence of a text written in a particular natural language and selecting a first spectrogram from among the spectrograms, to output the first spectrogram; and
a vocoder configured to generate a second speech signal corresponding to the sequence of the text based on the first spectrogram.

2. The speech synthesis system of claim 1, wherein the synthesizer is configured to perform at least once selecting the first spectrogram based on an alignment corresponding to each of the plurality of spectrograms.

3. The speech synthesis system of claim 2, wherein the synthesizer is configured to select the first spectrogram from among the spectrograms based on a pre-set threshold value and a score corresponding to the alignment, and,
when scores of all of the spectrograms are less than the pre-set threshold value, perform at least once the cycle including re-generating a plurality of spectrograms corresponding to verbal utterance of the sequence of the text and selecting a second spectrogram from among the spectrograms.

4. The speech synthesis system of claim 1, wherein the vocoder is configured to select one of a plurality of algorithms based on an expected quality and an expected generation speed of the second speech signal and generate the second speech signal based on the selected algorithm.

5. The speech synthesis system of claim 1, wherein the synthesizer comprises an encoder neural network and an attention-based decoder recurrent neural network,
the encoder neural network is configured to generate encoded representations of characters included in the sequence of the text by processing the sequence of the characters, and,
for each decoder input in a sequence input from the encoder neural network, the attention-based decoder recurrent neural network, process the decoder input and the encoded representation to generate a single frame of the spectrogram.

6. A method of generating a synthesized speech, the method comprising:
generating a speaker embedding vector corresponding to a verbal speech based on a first speech signal corresponding to a verbal utterance;
generating a plurality of spectrograms corresponding to verbal utterance of the sequence of the text based on the speaker embedding vector and a sequence of a text written in a particular natural language;
outputting a first spectrogram by performing at least once the cycle including generating the spectrograms and selecting the first spectrogram from among the generated spectrograms; and
generating a second speech signal corresponding to the sequence of the text based on the first spectrogram.

7. The method of claim 6, wherein, in the outputting,
the selecting of the first spectrogram based on an alignment corresponding to each of the plurality of spectrograms is performed at least once.

8. The method of claim 7, wherein the outputting comprises:
selecting the first spectrogram from among the spectrograms based on a pre-set threshold value and a score corresponding to the alignment, and,
when scores of all of the spectrograms are less than the pre-set threshold value, re-generating a plurality of spectrograms corresponding to verbal utterance of the sequence of the text,
wherein the re-generating is performed at least once.

9. The method of claim 6, wherein, in the generating of the second speech signal, one of a plurality of algorithms is selected based on an expected quality and an expected generation speed of the second speech signal and the second speech signal is generated based on the selected algorithm.

10. A non-transitory computer-readable recording medium storing instructions, when executed by one or more processors, to perform a method of generating a synthesized speech, the method comprising:
generating a speaker embedding vector corresponding to a verbal speech based on a first speech signal corresponding to a verbal utterance;
generating a plurality of spectrograms corresponding to verbal utterance of the sequence of the text based on the speaker embedding vector and a sequence of a text written in a particular natural language;
outputting a first spectrogram by performing at least once the cycle including generating the spectrograms and selecting the first spectrogram from among the generated spectrograms; and
generating a second speech signal corresponding to the sequence of the text based on the first spectrogram.
